(19) United States
(12) Patent Application Publication
(10) Pub. No.: US 2012/0173266 A1
(43) Pub. Date: Jul. 5, 2012

(54) REIMBURSING CARE PROVIDERS BASED ON PERFORMED ACTIONS

(75) Inventors: RYAN ALAN BRUSH, OVERLAND PARK, KS (US); BHARAT B. SUTARIYA, PARKVILLE, MO (US); PETER HARRISON YATES, KANSAS CITY, MO (US)

(73) Assignee: CERNER INNOVATION, INC., OVERLAND PARK, KS (US)

(21) Appl. No.: 13/340,859

(22) Filed: Dec. 30, 2011

Related U.S. Application Data
(60) Provisional application No. 61/428,632, filed on Dec. 30, 2010.

(51) Int. Cl. G06Q 50/22

(52) U.S. Cl. 705/2

(57) ABSTRACT

Methods, computer storage media, systems and user interfaces for reimbursing care providers using care tickets are provided. In embodiments, the method includes identifying a medically appropriate action(s) to perform during a clinical encounter for a patient that, if performed, results in a reimbursement to a care provider. The medically appropriate action(s) to perform during the clinical encounter for the patient is provided. An indication that the medically appropriate action(s) has been performed during the clinical encounter is received. Based on the performance of the medically appropriate action(s), reimbursement to the care provider is automatically initiated.

### CROSS-REFERENCE TO RELATED APPLICATIONS

This application claims the benefit of U.S. Provisional Patent Application No. 61/428,632, filed Dec. 30, 2010, entitled “Reimbursing Care Providers Using Care Plans,” which is assigned or under obligation of assignment to the same entity as this application and incorporated in this application by reference.

This application is related by subject matter to U.S. patent application Ser. No. ______ filed even date herewith and entitled “Developing and Managing Care Tickets” (attorney docket number CRNI.160524); U.S. patent application Ser. No. ______ filed even date herewith and entitled “Developing and Managing Personalized Plans of Health” (attorney docket number CRNI.164512); and U.S. patent application Ser. No. ______ filed even date herewith and entitled “Facilitating Identification of Potential Health Complications” (attorney docket number CRNI.164513), which are each assigned or under obligation of assignment to the same entity as this application, and incorporated in this application by reference.

### BACKGROUND

The health industry has placed an emphasis on improving the quality of healthcare provided to patients. In this regard, care providers make every effort to provide medically appropriate healthcare services for patients. Oftentimes, a care provider elects healthcare services to provide to a patient based on the reason for the patient's visit and/or healthcare data resulting from or acquired at previous visits to that particular care provider. Current processes for selecting healthcare services to provide to a patient suffer from various drawbacks. For example, the current processes of selecting healthcare services to provide to a patient are based on limited data provided to the care provider resulting in an improper or incomplete healthcare evaluation or diagnosis.

Further, as reimbursement for performance of healthcare services is important, care providers generally strive to perform healthcare services believed to be suitable for reimbursement. In existing systems, a claim in a paper or electronic form is forwarded to a payer for processing and payment. The payer processes the claim in accordance with constraints of the relevant policy and benefit plan contract. The payer analyzes the data submitted via the claim and determines whether the claim should be paid or denied. Such a process largely ignores the clinical data associated with the patient and the information related to the care provided and focuses mostly on the billing codes that summarize the care provided. In some cases, reimbursement may rely on a determination of medical appropriateness being made upon performing healthcare services and prior to initiating reimbursement. Providing healthcare services and, thereafter, determining whether reimbursement is appropriate can provide little assurance that healthcare services will be reimbursed. Further, some such selected healthcare services may be unnecessary or inappropriate. Additionally, the care provider may mistakenly overlook performing a healthcare service that is important to the well-being of the patient.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Utilizing the methods and systems described herein, computerized systems, methods, computer storage media having computer-executable instructions embodied thereon for performing the disclosed methods, and user interfaces for generating and managing personalized plans of health, or portions in association therewith, are provided. In one aspect, the present invention provides one or more computer storage media having computer-executable instructions embodied thereon for performing a method for reimbursing care providers. The method includes identifying one or more medically appropriate actions to perform during a clinical encounter for a patient that, if performed, result in a reimbursement to a care provider. The one or more medically appropriate actions to perform during the clinical encounter for the patient are provided. An indication that the one or more medically appropriate actions have been performed during the clinical encounter is received. Based on the performance of the one or more medically appropriate actions, reimbursement to the care provider is automatically initiated.

In another aspect, the present invention provides one or more computer storage media having computer-executable instructions embodied thereon for performing a method for reimbursing care providers. The method includes providing a care ticket associated with a patient for a particular clinical encounter. The care ticket includes one or more healthcare actions to perform during the particular clinical encounter that have been preapproved for reimbursement to a care provider. In response to an indication that the one or more healthcare actions were performed during the particular clinical encounter, reimbursement to the care provider for performance of the one or more healthcare actions is initiated.

In yet another aspect, the present invention provides a method for reimbursing care providers. The method includes identifying one or more healthcare actions to perform during a clinical encounter for a patient that, if performed, result in reimbursement to the care provider. The identified healthcare actions are based on clinical data associated with the patient and evidence-based data. Prior to providing the one or more healthcare actions in association with the clinical encounter, it is verified that the one or more healthcare actions are deemed acceptable for reimbursement for performance of the one or more healthcare actions. The one or more healthcare actions to perform during the clinical encounter for the patient are provided. An indication that at least one of the one or more healthcare actions have been performed during the clinical encounter is received. Based on the indication of performance of the at least one of the one or more healthcare actions, reimbursement to the care provider is initiated in real-time.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system suitable for use in implementing embodiments of the present invention;

FIG. 3 is another block diagram of an exemplary computing system suitable for use in implementing embodiments of the present invention;

FIG. 4 illustrates another block diagram of an exemplary computing system suitable for use in implementing embodiments of the present invention;

FIG. 5 is an illustrative screen display, in accordance with an embodiment of the present invention, of an exemplary user interface for viewing risk data;

FIG. 6 is an illustrative screen display of an exemplary user interface for viewing a risk profile, in accordance with an embodiment of the present invention;

FIG. 7 is an illustrative screen display of a first exemplary user interface for viewing a care ticket, or a portion thereof, in accordance with an embodiment of the present invention;

FIG. 8 is an illustrative screen display of a second exemplary user interface for viewing a care ticket, or a portion thereof, in accordance with an embodiment of the present invention;

FIGS. 9-11 illustrate another exemplary user interface for viewing a care ticket, according to an embodiment of the present invention;

FIG. 12 is a flow diagram showing a method for facilitating avoidance of potential health complications, in accordance with an embodiment of the present invention;

FIG. 13 is a flow diagram showing a first method for facilitating developing a personalized plan of health, in accordance with an embodiment of the present invention;

FIG. 14 is a flow diagram showing a second method for facilitating developing a personalized plan of health, in accordance with an embodiment of the present invention;

FIG. 15 is a flow diagram showing a method for developing a care plan, in accordance with an embodiment of the present invention;

FIG. 16 is a flow diagram showing a method for developing a care ticket, in accordance with an embodiment of the present invention;

FIG. 17 is a flow diagram showing another method for developing a care ticket, in accordance with an embodiment of the present invention;

FIG. 18 is a flow diagram showing a method for presenting a care item, in accordance with an embodiment of the present invention;

FIG. 19 is a flow diagram showing a first method for reimbursing a care provider, in accordance with an embodiment of the present invention;

FIG. 20 is a flow diagram showing a second method for reimbursing a care provider, in accordance with an embodiment of the present invention; and

FIG. 21 is a flow diagram showing a third method for reimbursing a care provider, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems for developing and managing personalized plans of health (hereinafter also referred to as “PPH”), and portions associated therewith. Utilizing the methods and systems described herein, a PPH is developed for a patient to provide a plan of health care for the patient in accordance with the overall healthcare history of the patient. Such a PPH is intended to improve or maintain a patient's health by indicating, among other things, appropriate healthcare actions corresponding to the patient while taking into consideration the health history of the patient (e.g., in its entirety) and evidence-based data. Generally, a PPH is directed to affecting and managing a patient's health over their lifetime, for example, by way of a day-to-day basis.

Having briefly described embodiments of the present invention, an exemplary operating environment suitable for use in implementing embodiments of the present invention is described below.

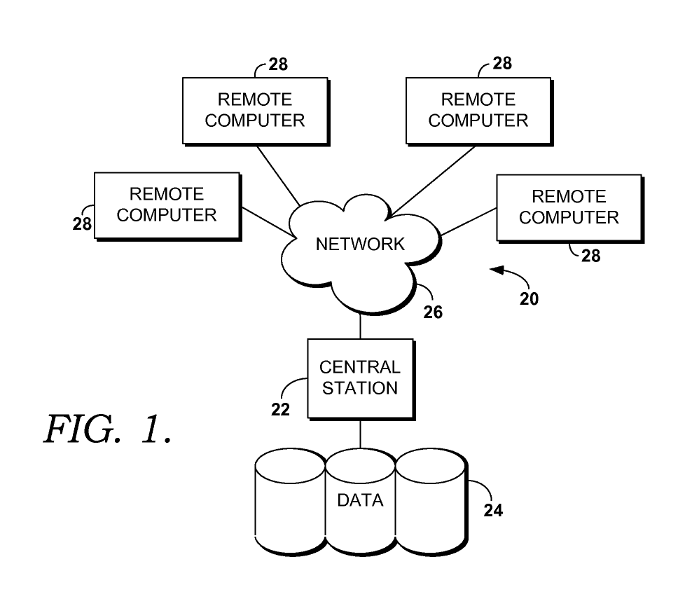

Referring to the drawings in general, and initially to FIG. 1 in particular, an exemplary computing system environment, for instance, a health information computing system environment, with which embodiments of the present invention may be implemented is illustrated and designated generally as reference numeral 20. It will be understood and appreciated by those of ordinary skill in the art that the illustrated health information computing system environment 20 is merely an example of one suitable computing environment and is not intended to suggest any limitation as to the scope of use or functionality of the invention. Neither should the health information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, tablets, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 1, the exemplary health information computing system environment 20 includes one or more general purpose computing devices in the form of a central station 22. Central station 22 may be a distributed computing system, a centralized computing system, a single computer such as a desktop, server, or laptop computer, or a networked computing system. Components of a general purpose computing device of the central station 22 may include, without limitation, a processing unit, internal system memory, and a suitable system bus for coupling various system components, including database cluster 24, with the computing device. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The central station 22 typically includes therein, or has access to, a variety of computer-readable media, for instance, database cluster 24. Computer-readable media can be any available media that may be accessed by central station 22, and includes volatile and nonvolatile media, as well as removable and non-removable media. By way of example, and not limitation, computer-readable media may include computer storage media and communication media. Computer storage media may include volatile and nonvolatile media, as well as removable and non-removable media implemented in any method or technology for storage of information, such as computer-readable instructions, data structures, program modules, or other data. In this regard, computer storage media may include RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the central station 22. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 24, provide storage of computer-readable instructions, data structures, program modules, and other data for the central station 22.

The central station 22 may operate in a computer network 26 using logical connections to one or more remote computers 28. Remote computers 28 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the elements described above in relation to the central station 22. The devices can be personal digital assistants, handheld devices, tablets, or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the central station 22 may include a modem or other means for establishing communications over the WAN, such as the Internet. In a networked environment, program modules or portions thereof may be stored in association with the central station 22, the database cluster 24, or any of the remote computers 28. For example, and not by way of limitation, various application programs may reside on the memory associated with any of the one or more of the remote computers 28. It will be appreciated by those of ordinary skill in the art that the network connections shown are exemplary and other means of establishing a communications link between the computers (e.g., central station 22 and remote computers 28) may be utilized.

In operation, a clinician may enter commands and information into the central station 22 or convey the commands and information to the central station 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the central station 22. In addition to a monitor, the central station 22 and/or remote computers 28 may include other peripheral output devices, such as speakers and a printer.

Although many other internal components of the one or more computing devices of the central station 22 and the remote computers 28 are not shown, those of ordinary skill in the art will appreciate that such components and their interconnection are well known. Accordingly, additional details concerning the internal construction of the computing devices of the central station 22 and the remote computers 28 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the generation and management of personalized plans of health, and/or components associated therewith. As contemplated by the language above, the methods and systems of embodiments of the present invention may also be implemented on a stand-alone desktop, personal computer, or any other computing device used in a healthcare environment or any of a number of other locations.

As previously mentioned, embodiments of the present invention relate to methods, systems, and computer-readable media for use in, e.g., a healthcare environment, for developing and/or managing personalized plans of health, or portions associated therewith. For simplicity, the particular user will often be referred to herein as a user, a care provider, or a clinician. However, it will be understood that the particular user may be any healthcare professional, physician, or other provider, as described above.

As used herein, a personalized plan of health or a PPH refers to a healthcare plan, profile, or outline of medical care or healthcare to provide in association with a patient (i.e., an individual receiving care). A PPH enables a more efficient and effective manner to manage a patient's health. In this regard, a PPH may include suggested, recommended, or required healthcare or medical care guidelines, procedures, goals, medications to take or prescribe, or actions to perform in association with a patient to achieve optimum health benefits for the patient. The terms “medical” and “health” may be used interchangeably herein. Accordingly, health care, healthcare, and medical care are each directed to any care related to the health or medical practice.

In embodiments, a PPH is associated with a particular medical condition(s) corresponding with a patient. As such, the PPH enables a more efficient and effective manner for managing a particular medical condition(s) of a patient. For example, a PPH can result in better medical care being provided to a patient having a chronic or episodic medical condition (e.g., diabetes). Alternatively or additionally, a PPH is associated with the general health of a patient, for example, including the general well-being of the patient and any medical conditions or potential medical conditions of the patient.

In embodiments, a PPH includes or can be utilized to develop, generate or update one or more care tickets. A care ticket refers to healthcare information associated with a patient in the context of a particular clinical encounter (e.g., a medical or healthcare appointment, a point-of-care service). In this regard, a care ticket includes healthcare information associated with a patient that is relevant to or can be performed in connection with a particular clinical encounter, or a reason thereof. Such relevant healthcare information can be obtained or derived from, for example, a PPH or other patient data. A care ticket may include, for example, a care plan, a quality measurement(s), a reason(s) for visit, patient history data, a patient medication(s), a healthcare or medical result(s), a visit summary, a self-reported activity(s), a financial value(s), and/or the like. A care plan refers to a set of one or more actions (i.e., health or medical actions) designated, recommended, suggested, or required to be performed (e.g., initiated or completed) in association with a patient at a particular clinical encounter (e.g., a medical appointment, a point-of-care service).

In this regard, in connection with developing a PPH for a patient, one or more care tickets and/or care plans can be developed for the patient in advance of a clinical encounter. Alternatively or additionally, at a clinical encounter, one or more care tickets and/or care plans can be developed in real-time for a patient using the PPH. A clinical encounter refers to a point-of-care service at which healthcare or medical services are provided to a patient by a care provider. A care provider is an entity that provides health or medical care or services to a patient including, but not limited to, a clinician, a hospital, etc. Healthcare or medical care services may be provided at any of a number of care provider locations including, for example, hospitals, other inpatient settings, pharmacies, a clinician's office, ambulatory settings, testing labs and a person's home environment. In an embodiment, one or more computing devices are located at, or associated with, each care provider location and receive clinical data for storage at one or more data stores located at, or associated with, each care provider location. For example, the computing devices and data stores may be physically located at the provider's physical locations, at remote locations at which the health care information technology systems are hosted, or distributed there between.

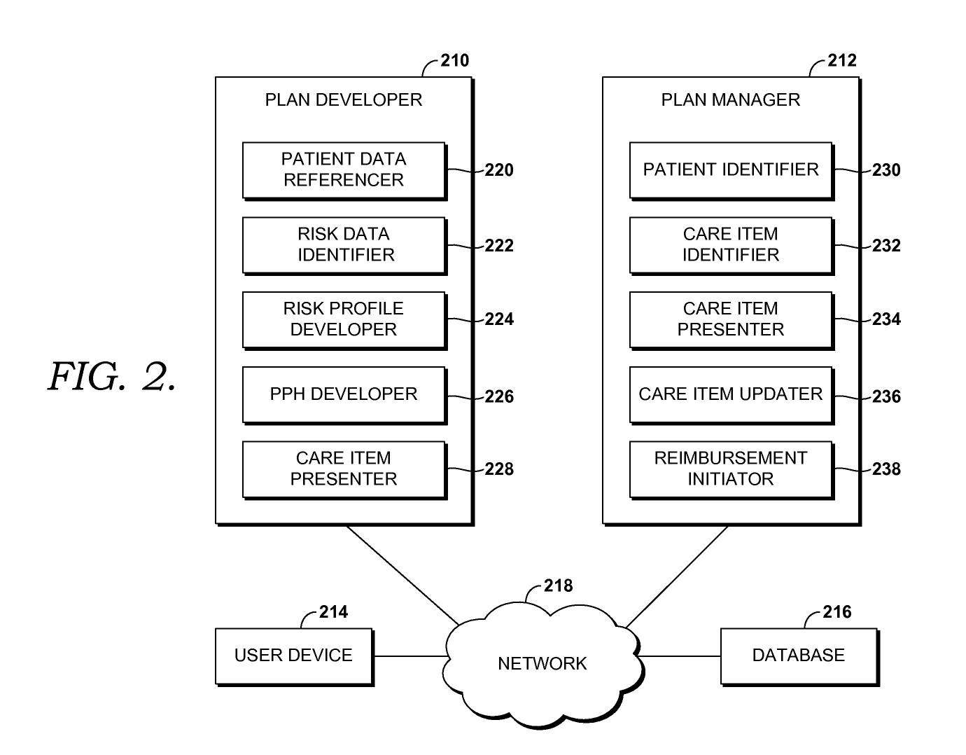

With reference to FIG. 2, an exemplary system suitable for use in implementing embodiments of the present invention is shown and designated generally as reference numeral 200. System 200 includes a plan developer 210, a plan manager 212, a user device 214, and a database 216, all in communication with one another through a network 218. The network 218 may include, without limitation, one or more local area networks (LANs) and/or wide area networks (WANs). Such networking environments are commonplace in offices, enterprise-wide computer networks, intranets, and the Internet. Accordingly, the network 218 is not further described herein.

The database 216 is configured to store information associated with at least one patient. In various embodiments, such information may include, without limitation, personalized plans of health, care plans, care tickets, patient identifiers, clinician identifiers, care provider identifiers, risk data, patient data, clinical data, financial data, activity data, risk profiles, and the like. In embodiments, the database 216 is configured to be searchable for one or more personalized plans of health, care plans, care tickets, patient identifiers, clinician identifiers, care provider identifiers, risk data, patient data, clinical data, financial data, activity data, risk profiles, and/or associated values stored in association therewith. It will be understood and appreciated by those of ordinary skill in the art that the information stored in the database 216 may be configurable and may include any information relevant to personalized plans of health, care plans, care tickets, patient identifiers, patients, clinician identifiers, clinicians, care provider identifiers, risk data, clinical data, risk profiles, patient data, financial data, activity data, and/or the like. The content and volume of such information are not intended to limit the scope of embodiments of the present invention in any way. Further, though illustrated as a single, independent component, database 216 may, in fact, be a plurality of databases, for instance, a database cluster, portions of which may reside on a computing device associated with the plan developer 210, the plan manager 212, the user device 214, another external computing device (not shown), and/or any combination thereof.

In embodiments, the plan developer 210 and/or the plan manager 212 may be a part of or associated with the central station 22 of FIG. 1. In one embodiment, the plan developer 210 and the plan manager 212 may reside within one computing device (e.g., a server) of the central station 22 of FIG. 1. In another embodiment, the plan developer 210 and/or the plan manager 212 may reside on multiple computing devices of the central station 22 of FIG. 1. For example, various functions may be distributed among multiple locations such as a local client and one or more remote servers (e.g., via a cloud-computing or distributed computing architecture). As can be appreciated, in some embodiments, any portion or all of the plan developer 210 and/or the plan manager 212 resides on the user device 214 or other computing device.

The plan developer 210 includes various components and is generally configured to develop, generate, and/or update personalized plans of health, and/or portions thereof (e.g., a care ticket and/or care plan). As previously mentioned, a PPH, a care plan, and/or a care ticket for a patient can be generated at any time prior to a clinical encounter (e.g., account setup, appointment setup, program enrollment, etc.) or at a clinical encounter (e.g., upon patient check in, a patient appointment, etc.) In embodiments, the plan developer 210 includes a patient data referencer 220, a risk data identifier 222, a risk profile developer 224, a PPH developer 226, and a care item presenter 228.

The patient data referencer 220 is configured to reference patient data. Patient data, as used herein, refers to any healthcare or medical care data related or relevant to a patient. Patient data may include, but is not limited to, clinical data, financial data, and activity data. Clinical data, as used herein, refers to any healthcare or medical data particular to a patient. In embodiments, clinical data is medical care or healthcare data resulting from or associated with a health or medical service performed in association with a clinician in a healthcare environment (e.g., lab test, clinical encounter, ecare, evisit, etc.). Clinical data may include, but is not limited to, a health history of a patient, patient information, patient demographics (e.g., age, gender, race, etc.), a diagnosis, a treatment, a family history, an immunization record, a medication, a test result, an allergy, a reaction, a procedure performed, a social history, an advanced directive, an alert, claims data, a vital, data traditionally captured at the point of care or during the care process, a combination thereof, and the like. Financial data refers to any financial information relevant to a patient, such as insurance data, claims data, payer data, etc. Activity data refers to health actions or activities performed by a patient outside of or remote from a healthcare environment. For example, activity data may capture nutrition information, exercise information, or nutrient information for a patient. Such patient data (e.g., clinical data, financial data, activity data) may be submitted by a patient, a care provider, a payer, etc. A payer refers to an entity that intends to pay or is responsible for payment of healthcare services. Payers include without limitation employers, government entities (such as Centers for Medicare and Medicaid Services), charities, patients, insurers and secondary insurers.

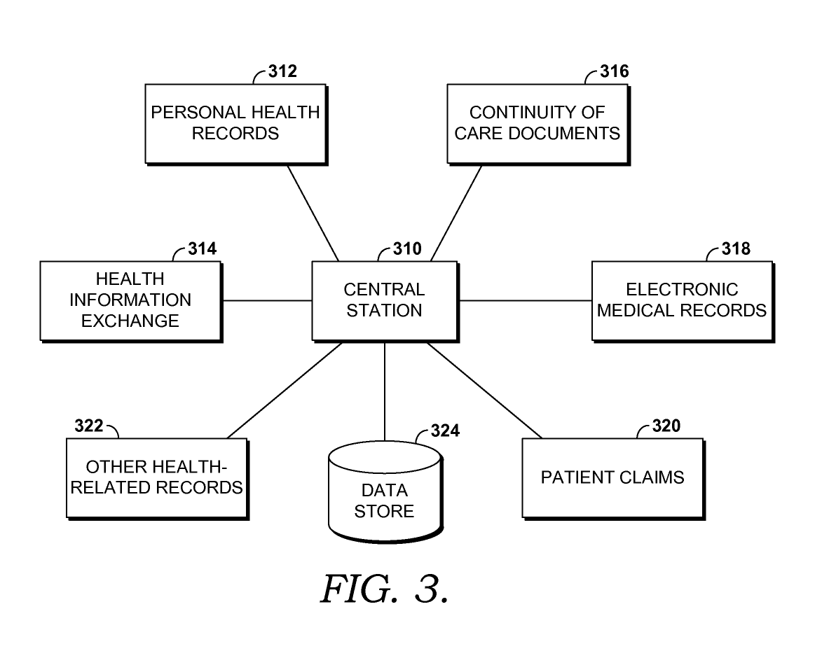

In embodiments, the patient data referencer 220 references patient data associated with a particular patient. Such patient data can be referenced from various sources or can be referenced from a single source, for example, that contains aggregated patient data from multiple sources (e.g., all available sources). In embodiments, a central station and/or data store, such as central station 22 and database cluster 24 of FIG. 1, or a portion thereof, aggregates data from multiple sources (e.g., all available sources) for a patient. As illustrated in FIG. 3, the central station 310 can extract and/or aggregate data from various sources including, for example, personal health record(s) (PHR) 312, health information exchange (HIE) 314, continuity of care document(s) (CCD) 316, electronic medical record(s) (EMR) 318, patient claims 320, and/or other health-related records or information 322 (e.g., claims data, patient demographics, patient health risk assessments, or activity data associated with a patient). A CCD, as used herein, refers generally to a patient document for a specific patient encounter. A CCD may be generated for each clinical encounter. For example, if Patient John is examined by Clinician A on Monday, a CCD for that clinical encounter may be generated. Additionally, if Patient John sees Clinician B on Wednesday, a different CCD for the encounter with Clinician B may be generated. A CCD may include data for multiple clinical encounters, as well. As CCDs are typically episodic, meaning that the CCD includes data for a single clinical encounter, the complete CCD is typically generated at the end of the clinical encounter, or when the patient's chart is closed. Alternatively, a CCD may be patient-centric in that it is generally inclusive of a patient's medical history.

Such patient data can be stored in a data store 324, for example, in association with the central station 310. Accordingly, the central station 310 receives or retrieves patient data from a plurality of sources (e.g., PHR, HIE, CCD, EMR, patient claims, etc.) and aggregates such data in association with a patient. The central station 310 may include an index of patient data for a patient(s) obtained from various sources. Such an index may enable searches using dynamic queries, for instance, based on a task, a data type, a patient, a clinician, etc.

Data store 324 includes patient data relevant to a patient(s). The data store may be a networked storage or distributed storage including storage on servers located in the cloud. Thus, it is contemplated that for some embodiments, the information stored in data store 324 is not stored in the same physical location. For example, one part of the data store may include one or more USB thumb drives or similar portable data storage media. The information within the data store may exist in a variety of formats including, for example, narratives and other data. As data may be received from various sources having various formats, the central station 310 may unify the data such that the data can be efficiently searched or may enable search of varied formats.

In one embodiment, patient data, or a portion thereof (e.g., a PPH, care ticket, care plan) can be stored and/or presented in association with a hyperlinked medical record representing the health of the patient. In this regard, data may be separated into documents based on content. For example, a set of one or more structured documents might exist for medications, while another set of one or more structured documents might exist for lab results. Such documents can be organized into a hierarchical structure. Each document can be referenced by a Uniform Resource Locator (URL). For instance, one URL might refer to a specific lab result. Further, documents might reference other elements or documents using hyperlinks, such as a collection of results linked by a physician visit from which a current document originated. Such a linking structure enables linking data from various sources. In this regard, multiple care providers can provide a partial view of medical records to a shared service that can provide a comprehensive overview of the health of the patient.

Returning to FIG. 2, in some embodiments, the patient data referencer 220 references patient data upon receiving an indication to develop, generate, or update a PPH, a care ticket(s), and/or a care plan(s) for a patient. In such embodiments, the patient data referencer 220 may be configured to receive an indication to generate or update a PPH, a care ticket(s), and/or a care plan(s) for a patient, for example, upon a clinician indicating such a desire. For example, a clinician may select a PPH indicator, a care ticket indicator, or a care plan indicator, such as an icon, to indicate a desire to generate or update a corresponding item for a patient. Such an indicator may be displayed in connection with the patient for whom a PPH, care ticket, or care plan is to be generated or updated. Alternatively, the patient data referencer 220 may automatically receive an indication to generate or update a PPH, a care ticket, or a care plan, for example, in association with each instance (or particular instances) that a medical information computer system is accessed; a medication or patient is selected; clinical data, financial data, or activity data is provided, updated, or modified; and/or the like.

The risk data identifier 222 is configured to identify risk data. Risk data refers to patient data that is relevant to a risk profile for a patient. In this regard, the risk data identifier 222 identifies risk data that may be used to develop a risk profile. By way of example, and not limitation, risk data may include data pertaining to history of a medical condition, test or laboratory results, etc. In some embodiments, risk data are patient data that relate to medical risks or potential medical risks (e.g., test result, laboratory result, diagnosis, health measures, etc.) associated with a particular medical condition(s). For example, risk data may include any data that is medically known to be associated with a particular medical condition (e.g., diabetes), irrespective of whether the patient data indicates a risk exists for the patient. For instance, risk data may include data associated with condition history (e.g., acute myocardial, bacteremia, congestive heart failure, chronic kidney disease, depression, etc.) and/or laboratory results (e.g., glucose level, LDL, serum creatinin, etc.) associated with a particular medical condition regardless of whether the data indicates a risk to the patient. In such embodiments, the risk data identifier 222 may reference or identify one or more medical risks or potential medical risks associated with a particular medical condition and, thereafter, identify, select, or designate any patient data related thereto as risk data.

In other embodiments, risk data might additionally or alternatively be any data that is medically known to indicate a medical risk to a patient. By way of example, and not limitation, patient data that is outside of a predetermined acceptable standard range or a predefined acceptable range for a specific patient may be identified as risk data. In such cases, the risk data identifier 222 may reference a knowledge base containing evidence-based knowledge and compare patient data (e.g., clinical data, activity data) associated with the patient to such evidence-based knowledge to determine whether particular patient data indicates a medical risk to the patient. Such a knowledge base may include, by way of example only, evidence-based standards of care, guidelines, procedures, recommended or best practices, clinical baselines, or other object data or normative information, and/or the like.

Identified risk data may be provided in connection with the source from which the data was obtained, referenced, extracted, etc. For example, clinical data received from a CCD record that is identified as a risk data may be associated with the source from which it was obtained (i.e., a CCD record) and, thereafter, stored and/or presented in connection therewith. In this regard, a user is able to readily recognize the source of the information. In some cases, the source (e.g., a CCD record) presented along with particular risk data may be easily navigated to via a link. Accordingly, a user may select a link to connect to the original source and corresponding data. A user may then be able to quickly recognize details regarding the recordation of the data in association with the original source, such as, for example, date/time of event associated with data, other clinical data associated therewith, etc. As can be appreciated, the identified risk data may additionally or alternatively be provided with other data relevant to the risk data, such as, for instance, a date/time associated with the data, etc.

The risk profile developer 224 is configured to develop risk profiles. The risk profile developer 224 can utilize the identified risk data to generate and/or update risk profiles. A risk profile, as used herein, refers to a set of one or more medical complications that may arise in association with a patient. In embodiments, the medical complications are associated with a particular medical condition(s) of the patient. The risk profile developer 224 utilizes the risk data to identify or predict one or more medical complications that may arise in association with a patient, for example, within a predetermined period of time. As can be appreciated, other data, such as other patient data associated with the patient or evidence-based data obtained from a knowledge base (e.g., evidence-based guidelines, outcomes, statistics, procedures, best practices, baselines, etc.) may also be used to identify medical complications that may result. Upon identifying potential medical complications, probabilities associated with such medical complications, a risk summary (e.g., a risk score), or the like may also be determined, for example, using evidence-based data.

As can be appreciated, in some cases, all potential medical complications associated with a patient or a particular medical condition(s) of a patient are identified and listed within a risk profile for the patient. In such cases, potential medical complications associated with the particular medical condition may be identified and a corresponding probability of the patient incurring the complication may be determined or calculated. In other cases, a portion of potential medical complications may be identified and associated with a particular patient and/or medical condition(s). For example, potential medical complications relevant to a particular medical condition, potential medical complications associated with data exceeding a threshold (e.g., a risk threshold), a predetermined number of potential medical complications, etc. may be selected for a risk profile.

By way of example only, assume a patient is 45 years of age, a female, a diabetic, and has a glucose measurement of 150 and a kidney function of 50. In such a case, the relevant patient data (including demographic data) and/or evidence-based knowledge can be used to predict any medical complications that might arise within the next twelve months. For instance, potential medical complications might include hypoglycemic episodes (e.g., 60% chance), urinary tract infections (e.g., 30% chance), etc. Such a prediction may be based on historical data of other patients, for example, other individuals having the same or similar demographics and/or patient data. Upon identifying specific medical complications that may arise for a patient, specific healthcare actions or incentives to avoid such complications can be identified and, thereafter, provided to the patient and/or care provider. For instance, healthcare actions to avoid the potential medical complication can be incorporated into a PPH, a care ticket, and/or a care plan for the patient.

The personalized plan of health (PPH) developer 226 is configured to generate and/or update personalized plans of health, care tickets, and/or care plans. The PPH developer 226 can utilize patient data, risk data, and/or risk profile associated with a patient to generate a PPH, a care ticket, and/or a care plan for the patient. As can be appreciated, other data, such as evidence-based data may also be used to generate a PPH, or a portion thereof. For instance, a knowledge base having evidence-based knowledge including, for example, standards of care, guidelines, procedures, recommended or best practices, clinical baselines, or other object data or normative information, and/or the like, can be accessed and utilized.

As previously mentioned, a PPH refers to a medical or healthcare plan, profile, or outline of health care to provide in association with a patient. A PPH enables a more efficient and effective manner to manage and maintain a patient's health. In this regard, a PPH may include suggested, recommended, or required medical or health guidelines, procedures, goals (e.g., target ranges or measures, frequency of medications or actions), medications to take or prescribe, or actions to perform (e.g., tests to run, measurements to take, vital signs to monitor, etc.) in association with a patient to achieve optimum health benefits for the patient. Such actions may be intended to improve or enhance the health of a patient and/or to minimize potential risks or complications that may arise in association with the patient.

A PPH is a health plan for a patient that can be derived from static and/or dynamic patient data, such as clinical data. Static data includes clinical data associated with the patient that does not change (e.g., race, gender), and dynamic data includes clinical data that is variable in association with the patient (e.g., heart rate, blood pressure, cholesterol, weight, etc.). The patient's data is compared to evidence-based data, knowledge, guidelines, and parameters, for example, stored in database 216, to generate a PPH for the patient. In this regard, a knowledge base is applied to health context associated with a patient to generate a personalized plan of health. Evidence-based data, for example from a knowledge base including medical or healthcare standards of care, literature, guidelines, procedures, recommended or best practices, clinical baselines, pattern recognition from past successes, other object data or normative information, or the like, can be utilized to determine data or information provided in a PPH. In this regard, healthcare information provided within a PPH can be identified based on information appropriate for a patient in light of the patient's changing health history.

As can be appreciated, a PPH for a patient can be dynamically generated and/or updated. For example, assume a PPH is initially generated for a patient prior to a clinical assessment being documented for use in a PPH (e.g., upon patient enrollment). Accordingly, only demographics, such as race, age and gender, may be available for the patient. In this regard, an initial PPH can be developed for the patient based on demographic information alone. For instance, because a patient is a 45 year old female, a recommendation for a mammogram may be included in the PPH for the patient based on evidence-based knowledge. Upon a basic screening (e.g., basic screening labs) and/or personal risk assessment (e.g., personal history form), an updated or modified PPH may now include a strong recommendation for a mammogram if the patient is associated with a risk of breast cancer (e.g., family history). Now assume that the patient visits a physician for assessment and advising. Upon completion of the physician visit, more clinical data is entered for the patient, such as medications, test results, diagnosis, etc. As more context is gathered for the patient, the PPH can provide more detailed or specific recommendations. In response to any changes or additions to clinical data for the patient, the PPH can be dynamically generated, modified, or updated to appropriately provide healthcare recommendations to the patient.

In embodiments, a PPH may include or be used to generate one or more care tickets and/or care plans. For example, a PPH for a patient may include a care ticket for a clinical encounter with a pediatrician, a care ticket for a clinical encounter with a podiatrist, and a care ticket for a clinical encounter with a physician specializing in diabetic care. As previously mentioned, a care ticket refers to healthcare information associated with a patient in the context of a particular clinical encounter (e.g., a medical appointment, a point-of-care service). Such a care ticket may include any information that facilitates a clinical encounter. By way of example, and not limitation, a care ticket may include a care plan, a quality measurement(s), a reason(s) for visit, a patient history (e.g., historical context), a patient medication(s), a healthcare result(s), a visit summary, a self-reported activity(s), a medical or healthcare goal(s) corresponding with the care plan, a medical or healthcare guideline(s), and/or the like. Such relevant healthcare information can be obtained or derived from, for example, a PPH or any other patient data including risk profile or risk data. Evidence-based data, for example from a knowledge base including medical or healthcare standards of care, literature, guidelines, procedures, recommended or best practices, clinical baselines, pattern recognition from past successes, other object data or normative information, or the like, can be utilized to determine data or information to provide in a care ticket and/or care plan.

A care plan refers to a set of one or more actions designated, suggested, recommended, or required to be performed (e.g., initiated or completed) in association with a patient at a particular clinical encounter (e.g., a medical appointment, a point-of-care service). Accordingly, a care plan can include medical or healthcare actions to perform during or in connection with a clinical encounter. That is, a care plan provides details for executing health recommendations for a patient. Healthcare actions may include, but are not limited to, a procedure to perform or recommend, a test to perform or recommend, a vaccine to provide or recommend, a medication to prescribe or recommend, a follow-up visit to schedule or recommend, an exam to perform or recommend, a question to ask, data to collect, a vital to obtain, a diet to recommend, a nutrition to recommend, a physical activity to recommend, a screening to perform or recommend, etc.

Care tickets and/or care plans can be generated for a patient using patient data, risk data, risk profile, and/or PPH data based on the context of the specific clinical encounter. Context for a specific clinical encounter may be, but is not limited to, the clinician visited, the care provider visited, the reason for the visit, another care provider referral, a symptom of the patient's, etc. For example, assume that a patient is visiting a particular physician for hypertension and high cholesterol. In such a case, the particular physician being visited and the reason for the visit (i.e., hypertension and high cholesterol) can be utilized to identify data to include in a care ticket and/or care plan associated with the physician visit.

In some embodiments, at least a portion of a care ticket (e.g., a care plan) is generated based on care appropriateness in light of patient data associated with the patient and evidence-based knowledge. In this regard, one or more actions to perform during or in connection with a clinical encounter designated as appropriate are included within a care ticket (e.g., a care plan). Actions can be deemed appropriate in accordance with the particular patient, the health history of the patient, the particular clinical encounter (e.g., date or range of dates of the clinical encounter), the clinician associated with the clinical encounter (e.g., type of physician or particular physician), the reason for the visit, etc. As such, a care ticket or care plan can be derived, modified, or generated using, for example, demographic data, context of specific clinical encounter (e.g., reason for visit, physician being visited), clinical data (e.g., previous test dates and results, current medications), activity data, and/or financial data in combination with evidence-based knowledge.

As can be appreciated, appropriateness with respect to care tickets or plans can be recognized in any manner. Guidelines, standards of care and other normative information may be utilized to determine appropriateness of healthcare information provided within a care ticket and/or care plan. These may, for instance, include recommended or best practices for different categories of diseases, patients, or treatments as well as other clinical baseline or objective data. Clinical guidelines may include guidelines published or released by Zynx Health, Inc. or other content providers. Other sources of objective, evidence or research-based clinical guidelines and standards may be assessed or incorporated, such as for example data published or provided by the Joint Commission on Accreditation of Healthcare Organizations. Other public or private sources or combinations of sources of clinically-related criteria or guidelines may also be used.

In addition to or in the alternative to using evidence-based data and/or appropriateness to assess and determine actions to include in a care ticket and/or care plan, in some embodiments, financial data may be utilized. Financial data includes, for example, procedure codes, physician identification, insurance or other coverage data including co-pay and deductible amounts, eligibility requirements, benefit reimbursement levels, claims data, and the like. In this regard, at least a portion of actions selected and/or provided within a care ticket and/or care plan can be deemed acceptable and preapproved for reimbursement by the payer to the care provider for particular healthcare services performed during a clinical encounter. Accordingly, a payer may select, identify, or approve (e.g., automatically) actions to include in a care ticket and/or care plan for a patient that the payer recognizes as appropriate and acceptable for reimbursement based at least in part on financial data. Alternatively, a care ticket and/or care plan may be generated for a patient (e.g., utilizing payer data) and, thereafter, verified or confirmed (e.g., automatically) as acceptable for reimbursement, for example, based on financial data (e.g., insurance or coverage data).

As can be appreciated, a care ticket and/or care plan associated with a particular clinical encounter can be dynamically generated and/or updated. That is, a care ticket and/or care plan can be based on clinical data entered in association with one or more previous clinical encounters such that the care ticket and/or care plan is up-to-date and relevant to the patient. For example, assume a patient visits a physician and has a medical test performed (e.g., based on a suggested action in the care plan for that physician visit). Now assume that the patient subsequently visits a physician (either the same physician or another physician). The performance and/or results of the medical test previously performed can be reflected in the care ticket and/or care plan generated for the second physician visit. In this regard, an action for performing the medical test may not be included in the new care plan as it was recently performed during a physician visit or a particular action may be included in the new care plan based on the results of the medical test performed at the previous physician visit.

The care item presenter 228 is configured to present care items, such as personalized plans of health, care plans, care tickets, risk profiles, risk data, etc. A care item refers to a PPH, or an item associated with a PPH (e.g., care tickets, care plans, risk profiles, risk data). In some embodiments, the care item presenter 228 presents care items to other computing devices, for example, a remote user device such as user device 214 of FIG. 2, data stores, such as database 216, a plan manager such as plan manager 212 of FIG. 2, etc. In other embodiments, the care item presenter 228 displays care items to users upon receiving an indication to view a care item associated with a patient. For instance, a user may indicate a desire to view a care ticket for a particular patient. Accordingly, upon generating or updating the care ticket, the care item presenter 228 may facilitate displaying the care ticket to the user to view. Alternatively, a care ticket may be automatically displayed, for example, upon receiving a selection to view information pertaining to a patient, etc.

In an embodiment that aggregates patient data via a hyperlinked medical record, personalized plans of health, care tickets, and/or care plans can be integrated with the hyperlinked structure of the medical record. Such care items can be capable of linking to any supporting information. Accordingly, a PPH, care ticket, and/or care plan may be provided in connection with the source from which the data was obtained, referenced, extracted, etc. For instance, care tickets may be used to coordinate care between multiple entities (e.g., patient and one or more care providers). By way of example only, assume that an open care ticket is posted to an Internet-based repository containing links to pertinent health information. A user, such as a clinician or patient, might be prompted for information relevant to the care ticket (e.g., symptoms applicable to a condition being managed or responses to a recommendation). Any responses provided by a user can be securely posted to the repository in a manner that preserves an overview of the patient's health and reflects the hyperlinked relation with related resources in the hierarchy.

Further, any related documents (e.g., care tickets) can be hyperlinked, such as to an original care ticket (e.g., such as initial visit for which follow-up visits were required), to retain a complete and accurate history of the care process. In this regard, a user is able to readily recognize the source of the information. In some cases, the source may be easily navigated to via a link. Accordingly, a user may select a link to connect to the original source and corresponding data. A user may then be able to quickly recognize details regarding the recordation of the data in association with the original source, such as, for example, date/time of event associated with data, other clinical data associated therewith, etc.

The plan manager 212 is generally directed to managing care items, such as personalized plans of health, care plans, care tickets, risk profiles, risk data, and/or the like. In this regard, the plan manager 212 may generally be utilized, for example, during a clinical encounter, to view risk data, a risk profile, a care plan, a care ticket, a PPH, or the like; to update patient data or care items associated with a patient; and/or to initiate reimbursement to the care provider for healthcare services provided to the patient in association with a clinical encounter. In embodiments, the plan manager 212 includes a patient identifier 230, a care item identifier 232, a care item presenter 234, a care item updater 236, and a reimbursement initiator 238.

The patient identifier 230 is configured to identify a patient for which to manage a care item(s). A patient may be identified, for example, based on an input patient identifier, a patient identifier identified upon a user swiping a patient card (e.g., a medical card), or the like. By way of example only, a clinician or patient may swipe a patient card or input a patient identifier (i.e., patient ID number, patient name, patient date of birth, and/or the like) and, thereafter, the patient identifier 230 may identify the patient for which to manage (e.g., present) a PPH, a care ticket, and/or a care plan, etc.

The care item identifier 232 is configured to identify a care item(s), such as a PPH(s), care plan(s), or a care ticket(s), associated with a patient, for example, using the patient identifier identified by patient identifier 230. In some cases, the care item identifier 232 identifies a care item upon receiving an indication to manage a particular care item. Accordingly, a user may select to view a PPH, a care plan, or a care ticket for a particular patient and, in response, an appropriate care item associated with the patient is identified.

As previously discussed, in some cases, care items are generated, for example, by the plan developer 210, in advance of a clinical encounter. In such cases, the care item identifier 232 identifies the preexisting care item(s) associated with a particular patient. For example, a lookup system or algorithm may be used to identify a care ticket generated for a particular patient. While care items may generally be preexisting, in some cases, to identify a care item, a care item may need to be updated to incorporate any recent modifications or updates to patient data, risk data, PPH, etc. For example, in some cases, a PPH, care ticket, and/or care plan may be more optimal if updated based on recently added clinical data. In such cases, the care item identifier 232, the plan developer 210, the care item updater 236, or another component(s), may be utilized to update a care item.

In cases that care items (e.g., care tickets or care plans) are generated in advance of a clinical encounter, the care item identifier 232 identifies one or more appropriate care items associated with a particular patient. As more than one care ticket or care plan may exist for a patient, to select an appropriate care ticket/plan, a clinician or provider identifier may be required, for example, as input by the user. Accordingly, the care item identifier 232 can utilize the patient identifier and the provider identifier to determine or identify a care ticket or care plan that is appropriate for a current or upcoming clinical encounter. By way of example, assume that a care ticket exists for a diabetic patient's visit to a podiatrist and another care ticket exists for a diabetic patient's visit to a pediatrician. In such a case, a clinician associated with the pediatrician visit may input a provider identifier to identify the pediatrician and a patient identifier to identify the patient such that the care item identifier 232 can select the care ticket associated with the diabetic patient's visit to the pediatrician.

To identify a care item that does not exist at the time of a clinical encounter, the care item may be generated by the care item identifier 232, or another component (e.g., plan developer 210), at the clinical encounter. In this regard, upon receiving a request to generate, update, or manage a care item for a patient, an appropriate care item corresponding with the patient can be generated or updated, as described more fully above in relation to the plan developer 210. As can be appreciated, a care ticket may be generated for a specific patient in relation to a particular care provider (e.g., as identified by a provider identifier). As can be appreciated, the newly generated or updated care item can reflect or incorporate any previous patient data added, deleted, or modified in association with the patient.

The care item presenter 234 is configured to present care items, such as PPHs, care plans, care tickets, risk profiles, or risk data selected or identified to be managed (e.g., viewed) by a user. In some embodiments, the care item presenter 234 presents care items to other computing devices, for example, a remote user device such as user device 214 of FIG. 2, data stores, such as database 216, etc. In other embodiments, the care item presenter 234 facilitates displaying care items to users upon receiving an indication to view a care item associated with a patient. For instance, at a clinical encounter, a user may indicate a desire to view a care ticket for a particular patient. Accordingly, upon identifying the care ticket, the care item presenter 234 may facilitate displaying the care ticket to the user to view. Alternatively, a care ticket may be automatically displayed, for example, upon receiving a selection to view information pertaining to a patient, etc.

The care item updater 236 is configured to facilitate updates of care items (e.g., PPHs, care plans, care tickets, risk profiles, risk data). Care items can be updated based on input received, for example, from a clinician at a clinical encounter. In this regard, a care item, such as a care ticket, may include one or more result locations for receiving input related to results or other feedback provided by a clinician with regard to actions provided in the care ticket. As such, the care item updater 236 can receive input via the care ticket indicating, for example, a result associated with performance of an action (e.g., a test or laboratory result, a vital signal, etc.) or that an action has been performed (e.g., a laboratory test has been ordered). Thereafter, the care item updater 236 can facilitate such data being input into the aggregated patient data for the patient to be used to subsequently (e.g., in real-time or at a later time) update a PPH, a care plan, a care ticket, risk data, risk profile, or other existing or future care items, etc.

The reimbursement initiator 238 is configured to facilitate reimbursement to a care provider. As previously mentioned, in advance of healthcare services provided at a clinical encounter, actions provided in a care ticket and/or care plan may be deemed acceptable or preapproved for reimbursement. For example, one or more actions within a care ticket or plan may be appropriate to be performed by a clinician at a clinical encounter and confirmed as appropriate for reimbursement to the care provider if such actions are performed. Accordingly, the reimbursement initiator 238 identifies that the actions, or a portion thereof, provided in a care ticket or care plan have been performed (e.g., completed or initiated) by a clinician at the clinical encounter. In this regard, the reimbursement initiator 238 recognizes the actions that have been performed in comparison to the actions recommended, suggested, or required.

Upon verifying that such actions have been performed, the reimbursement initiator 238 can initiate reimbursement. As the care ticket can be designated as appropriate and acceptable for reimbursement prior to healthcare services being provided at a clinical encounter, reimbursement can be immediately initiated upon verifying that necessary and preapproved actions within a care ticket or care plan have been performed. In this way, during the clinical encounter, the care provider can readily recognize (e.g., prior to or in association with providing healthcare services) that the care provided is consistent with medical appropriateness and/or preapproved actions and, therefore, will receive reimbursement. Further, upon verifying that actions required or recommended within a care ticket or care plan have been performed, reimbursement for care provided can be automatically initiated without having to verify after performance of healthcare services that the care provided to the patient was appropriate.

Upon recording performance of completing or initiating actions within the care ticket or care plan associated with a clinical encounter, reimbursement to the care provider can be automatically initiated in real-time for the clinical steps required to provide care. Patients are safer since variance is reduced and evidence is utilized to determine care tickets/plans using all clinical data associated with the patient. Payers are protected since inappropriate care is not reimbursed, and the provision of appropriate care will eliminate downstream costs due to bad outcomes. This allows the reimbursement to be set based on the actual care provided rather than a summary represented by one or more codes or groups of codes. It further allows reimbursement to be recognized by a care provider prior to providing care rather than providing care and, thereafter, determining if the care provided is medically appropriate before reimbursement is initiated.

As a clinician may determine at a clinical encounter that one or more medical actions provided in the care ticket or care plan are not appropriate for the particular patient or the particular clinical encounter, the reimbursement initiator 238 may allow the care provider to explain or justify the care provided or omitted. The reimbursement initiator 238, or another component, can then determine if the reason provided is acceptable, for example, using a pre-defined list of acceptable reasons, such that reimbursement for healthcare services provided can be initiated.

In some embodiments, an initial or base reimbursement may be determined and/or initiated based at least in part on the particular healthcare actions completed or initiated. Such an initial reimbursement can be based on, for example, performance of specific healthcare actions, performance of recommended healthcare actions, performance of a particular number of healthcare actions, or performance of all healthcare actions. The initial reimbursement can be modified or adjusted in accordance with any number of factors. For instance, an initial reimbursement might be modified or adjusted in response to a physician performing an optional healthcare action (e.g., a flu shot unrelated to the reason for the visit). In another example, an initial reimbursement might be modified or adjusted based on healthcare outcomes, that is, results or outcomes for the patient as a result of performance of a healthcare action. Additionally or alternatively, an initial reimbursement can be modified (i.e., increased or decreased) based on quality metrics, such as patient satisfaction (e.g., patient results, visit length, visit wait time, meet patient expectations, etc.), appropriateness, and/or the like. Such reimbursement adjustments might be based on the particular patient and/or an aggregate set of patients. For instance, assume a physician sees 100 patients with coughs throughout the year and 90 of the patients improved without a second visit. In such a case, a physician might receive a bonus or incentive payment based on the aggregate data for the group of patients. As can be appreciated, reimbursement to a care provider can be immediately adjusted (e.g., upon performing an optional action or reporting a desirable healthcare outcome) or can be adjusted at a later time (e.g., upon a performance or outcome of a set of patients or reporting a desirable healthcare outcome later resulting from an action initiated or performed at the present clinical encounter).

In one embodiment, reimbursement or incentive payment to a care provider is based on a payment for completion of healthcare actions (e.g., recommended healthcare actions), a payment for quality of care provided to the patient with respect to the current clinical encounter (e.g., timelineness, patient satisfaction, outcomes, etc.), and a payment for performance in connection with an aggregate set of patients (e.g., patient satisfaction, timeliness, outcomes, etc.).

As previously mentioned, the system 200 further includes a user device 214 in communication with the database 216, the plan developer 210, and the plan manager 212 via the network 218. The user device 214 may be associated with any type of computing device, such as computing device 100 described with reference to FIG. 1, for example. Though not shown in FIG. 2, the user device 214 typically includes at least one presentation module configured to present (e.g., display) one or more care items associated with a personalized plan of health. In this regard, the presentation module may be configured to present personalized plans of health, care tickets, care plans, risk profiles, etc. and utilize such care items to receive input related thereto.

It will be understood and appreciated by those of ordinary skill in the art that other components not shown may also be included with the system 200. Further, additional components not shown may also be included within any of the plan developer 210, the plan manager 212, the user device 214, the database 216, and/or any other device. Additionally, any components illustrated in FIG. 2 in association with the plan developer 210 or the plan manager 212 may additionally or alternatively be associated with any of the other illustrated modules, the user device 214, and/or another external computing device, e.g., a server, (not shown). Any and all such variations are contemplated to be within the scope of embodiments hereof.

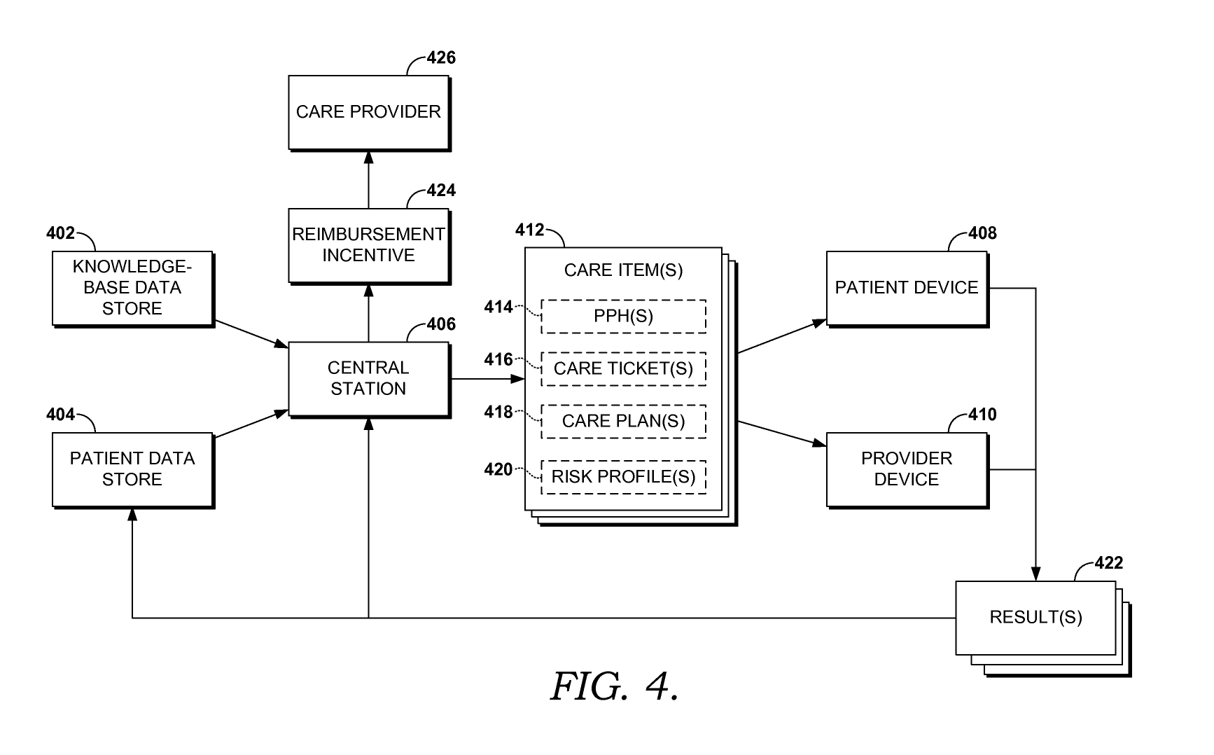

With reference to FIG. 4, FIG. 4 illustrates another exemplary system suitable for use in implementing embodiments of the present invention. The system includes a knowledge-base data store 402, a patient data store 404, a central station 406, a patient device 408, and a provider device 410. The knowledge-base data store 402 includes any evidence-based data that can be used to derive, generate, or update a care item (e.g., a PPH, a care ticket, a care plan, a risk profile, etc.) for a patient. For example, the knowledge-base data store 402 may include evidence-based standards of care, guidelines, procedures, recommended or best practices, clinical baselines, or other object data or normative information, and/or the like.

The patient data store 404 includes any patient data gathered or aggregated for a patient(s). Such patient data may include clinical data, financial data, activity data, or the like. In embodiments, patient data can be obtained from any number of sources including, for example, CCDs, health risk assessments, electronic medical records, system crawlers, manual entries, patient entries, clinician entries, etc. As can be appreciated, any number of data stores in any location can be utilized to store such information.

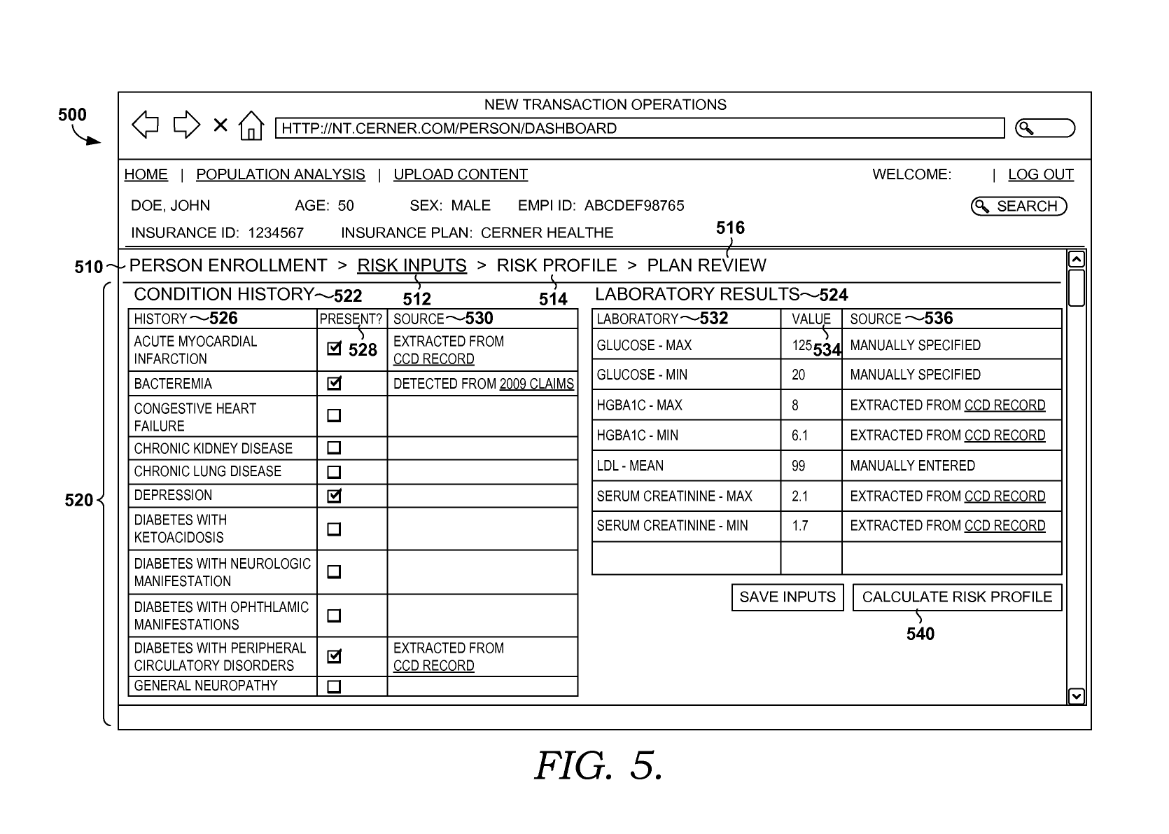

In embodiments, data stored within the patient data store 404 is standardized. Such data may go through a variety of transformations to be standardized and executable by the central station 406. In this regard, incoming raw data, such as the results 422, is persisted and leveraged as a source (e.g., source 530 in FIG. 5). The incoming raw data, however, may be unstructured or semi-structured thereby requiring a series of Medical Language Processing steps (e.g., nCode) and mapping onto a standardized nomenclature, such as UMLS. As such, the central station 406 can focus on providing clinical value rather than reconciling different structures of incoming data.

The central station 406 can be any computing system, such as a computer, a server, a network of servers, etc. The central station 406 utilizes the data from the knowledge-base data store 402 and the patient data store 404 to generate or update care items, such as PPHs, care tickets, care plans, risk profiles, etc. Such data can be accessed by the central station 406 by receiving, retrieving, or otherwise referencing the patient data and the evidence-based data.

In one embodiment, the central station 406 develops one or more care items 412 for a patient, as described in relation to FIG. 2. For example, the central station 406 may develop a PPH(s) 414, a care ticket(s) 416, a care plan(s) 418, a risk profile(s) 420, or the like. The care item(s) 412 can be stored in any data store, such as patient data store 404 or another data store. In embodiments, a care item(s) 412 can be used to generate or update another care item(s) 412. For instance, the PPH(s) 414 can be used to generate or update one or more care tickets 416 for the patient, one or more care plans 418 for the patient, and/or one or more risk profiles 420 for the patient. For example, a patient may have a first care ticket for one physician visit and a second care ticket for a different physician visit. Similarly, the risk profile(s) 420 can be used to generate or update one or more PPH(s) 414, one or more care tickets 416 for the patient, and/or one or more care plans 418 for the patient. As can be appreciated, the care item(s) 412 can be transmitted to a user, such as a patient or a care provider, and/or can be stored for subsequent reference.

As illustrated in FIG. 4, the one or more care items 412 can be transmitted to a patient device 408 and/or a provider device 410. Such care item(s) 412 can be automatically transferred or transferred based on a request to view a corresponding care item. Upon receiving the care item(s) 412, the patient or care provider can the view the appropriate care item. Any results 422 associated with actions or activities (e.g., healthcare actions provided in a care ticket or care plan) performed, completed, or initiated by the patient or care provider can then be provided back to the patient data store 404 or provided to the central station 406 to be directly reflected in an updated care item (e.g., the same care item or a different care item). Any other patient data entered (e.g., automatically or manually) by the patient or care provider can also be provided back to the patient data store 404 or directly provided to the central station 406 to be immediately reflected in a care item. Accordingly, any newly entered, deleted, or modified data obtained at the patient data store 404 and/or the central station 406 can be used to updated a care item in light of the newly acquired patient data.

The reported actions or activities can be used to initiate reimbursement to the care provider. In this way, healthcare actions performed, for example, by the patient or care provider, or results thereof, can be compared to actions required or recommended within an initial care ticket. Such a comparison might be performed, for instance, by the central station 406 or another component. Any applicable reimbursements or incentives triggered can then be calculated or reconciled. For instance, completed or initiated actions performed by a care provider that correspond with the required actions can be recognized and used to determine an amount to reimburse the care provider. Such an identified reimbursement or incentive payment 424 can be initiated (e.g., automatically in real-time) for the appropriate care provider 426.

By way of example and with reference to FIG. 4, assume that the central station 406 generates a PPH for a patient using patient data from the patient data store 404 and knowledge-based data from the knowledge-base data store 402. Such a PPH can be transmitted to the patient device 408 for viewing, the provider device 410 for viewing, and/or stored for subsequent use (e.g., patient data store). Now assume that the patient subsequently visits a care provider associated with the provider device 410. The central station can then generate a care ticket in accordance with the context of the clinical encounter (e.g., attending care provider, reason for visit, etc.). The care ticket can be generated using, for example, patient data, knowledge-based data, risk data, the PPH previously generated, etc. The care ticket is displayed to the care provider during the clinical encounter via the provider device 410.

Assume that the care ticket requires three healthcare actions to be completed by the care provider to be reimbursed for care provided and also provides an optional healthcare action that, if performed, will also be reimbursed. Such required and optional actions can be indicated as such to the care provider such that the care provider is informed prior to performing any healthcare actions what specifically will be reimbursed. Upon reviewing the required and optional healthcare actions, assume that the care provider performs each of the actions by initiating or completing such actions. Accordingly, the care provider provides an indication, via the provider device 410, that each healthcare action has been performed and/or provides results in associated with the healthcare actions. The indication of performance of the healthcare actions and/or corresponding results can then be transmitted to the patient data store 404 and/or the central station 406.

The central station 406 can use the newly acquired information to update the PPH previously generated and/or any other care items (e.g., risk profile, care plans, care tickets, etc.). Additionally or alternatively, the central station 406 can use the newly acquired information to initiate reimbursement to the care provider 426. In this regard, because the three actions required for reimbursement were performed, a corresponding initial reimbursement can be calculated or referenced (e.g., previously identified when generating the care ticket for the specific clinical encounter). Further, because the optional action was performed, an additional reimbursement or incentive can be calculated or referenced. Upon identifying an amount of reimbursement and incentive, such payment can be initiated and provided to the care provider 426. As can be appreciated, in some embodiments, the care provider 426 is generally associated with the provider device 410.

FIGS. 5-9 illustrate exemplary displays of graphical user interfaces for generating and managing personalized plans of health, according to embodiments of the present invention. The displays may be any electronic display wherein clinicians have access to manage a care item(s). The displays described herein may be displayed on user device 214 of FIG. 2. A clinician or patient can interact with the displays using well known input components—such as, for example, a mouse, joystick, stylus, touch screen, keyboard, or the like. Although FIGS. 5-9 illustrate a specific implementation, as can be appreciated, exemplary displays for generating and managing care plans can be configured in any manner and may include additional or alternative data.

By way of illustration only, the exemplary display 500 of FIG. 5 shows a view of selected risk data. With reference to FIG. 5, suppose, for instance, that a clinician accesses John Doe's record. In accessing John Doe's record, the clinician may view, among others items, person enrollment 510, risk inputs 512, risk profile 514, and plan review 516. Suppose further that the clinician selects to view risk inputs 512. Upon searching for and selecting risk data associated with John Doe, risk data 520 is displayed to a user. As illustrated in FIG. 5, risk data 520 includes a condition history area 522 and a laboratory results area 524. The condition history area 522 includes a history column 526, a present column 528, and a source column 530. The history column 526 includes a list of diagnosis or conditions. The present column 528 includes indications of whether the corresponding diagnosis or condition is present in association with the patient.

The source column 530 identifies the source within which data regarding the corresponding diagnosis or condition was obtained. As can be appreciated, a user may link to the source and corresponding data, for example, via a link to the source. Linking back to the original source data enables clinicians to validate the data shown in the summary view with information from the original record. Without being able to correlate items with the source, users may be less likely to trust the displayed content. In some embodiments, the links to source records and/or the source records may be backed by, for example, data provided to the patient data store 404 of FIG. 4.

The laboratory results area includes a laboratory column 532, a value column 534, and a source column 536. The laboratory column 532 includes a list of types of laboratory tests that have been provided to the patient. The value column 534 provides results corresponding with the laboratory tests. The source column 536 identifies the source within which data regarding the corresponding laboratory test was obtained (e.g., manually specified, extracted from CCD record, manually entered, etc.). A calculate risk profile indicator 540 can be selected by a user to initiate calculations for the risk profile. As previously discussed, the selected risk data might be clinical data associated with a particular medical condition, clinical data corresponding with a possible risk to the patient, etc.

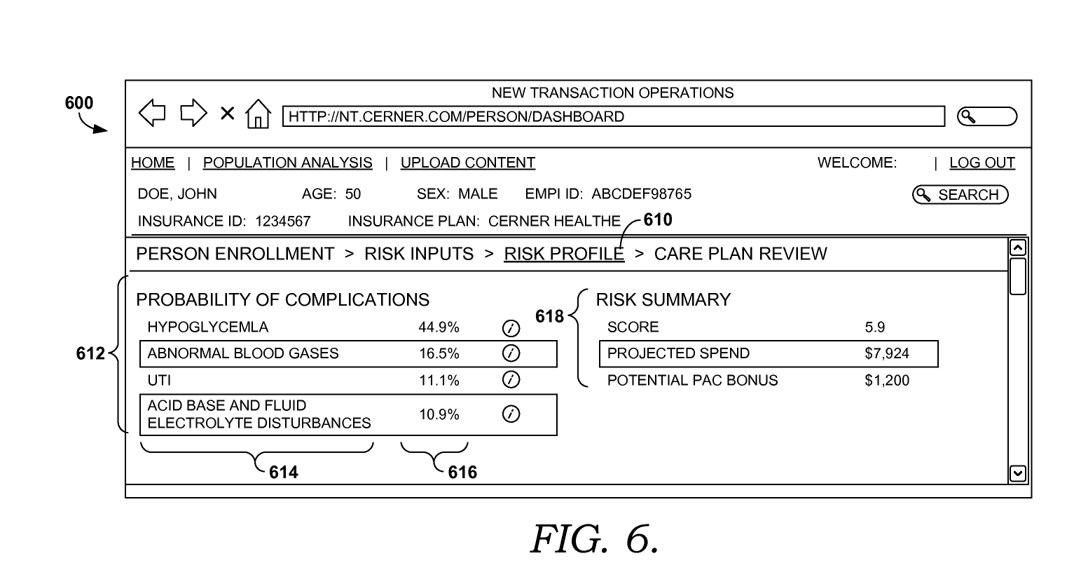

The exemplary display 600 of FIG. 6 shows a view of a risk profile. A clinician may select to view a risk profile 610 as illustrated in FIG. 6. Upon identifying the risk profile, risk profile 612 is displayed to a user. As can be appreciated, such a risk profile 612 can be generated based on risk data (e.g., as illustrated in FIG. 5), knowledge-based data, patient data, etc. As illustrated in FIG. 6, risk profile 612 includes a complications listing 614, a probability of complications area 616, and a risk summary area 618. The complications listing 614 may include a list of medical or healthcare complications that may arise in relation to the patient. The probability of complications area 616 includes probabilities, measures, extents, or values corresponding with the complications (e.g., percent of predicted risk for the patient to develop or incur the corresponding complication within a specific time frame). The risk summary area 618 includes a summary of risks associated with the patient. For example, the risk summary area 618 may include a risk score, a projected spend, a potentially avoidable complication (PAC) bonus, etc.

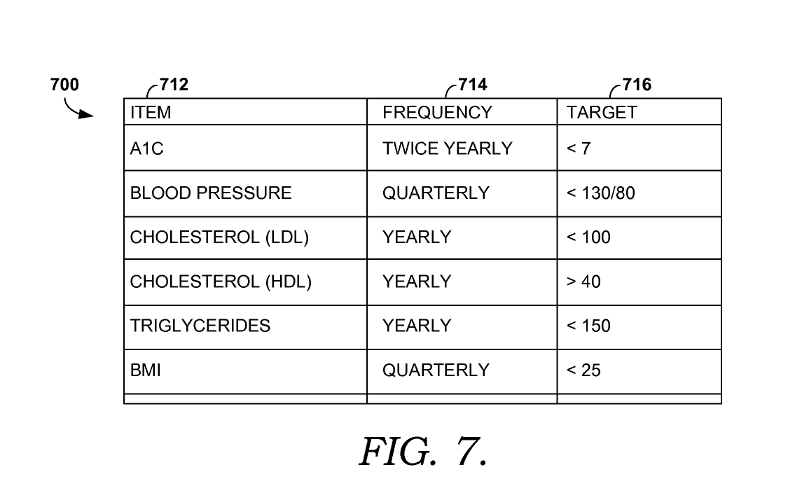

The exemplary display 7 of FIG. 7 illustrates a view of a portion of a care ticket (e.g., a care plan). A clinician may select to view a care ticket 700 as illustrated in FIG. 7. Upon generating a care ticket, a portion of a care ticket 700 can be displayed to a user. As illustrated in FIG. 7, the care ticket 700 includes an item area 712, a frequency area 714, and a target area 716. The item area 1012 may include any item associated with a care ticket or PPH, such as actions to perform (e.g., medical tests to perform, vital signals to obtain, etc.). The frequency area 714 includes a frequency associated with such items. For instance, the frequency area 714 may include a number of instances that an action included within the item area 712 should be performed within a particular time frame. The target area 716 includes a target result. For instance, the target area 716 may include target results that correspond with actions listed within the item area 712.

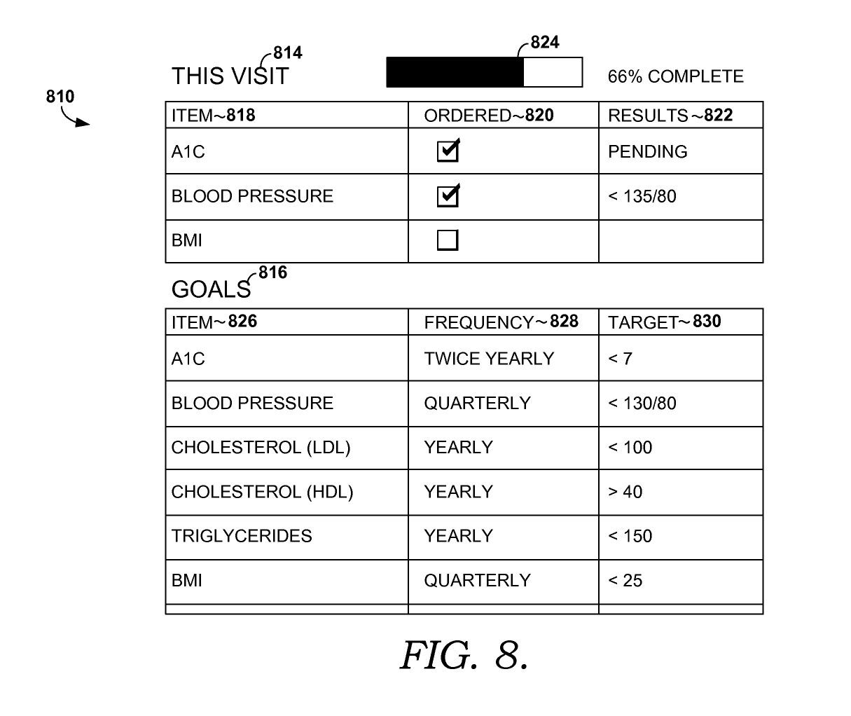

With reference to FIG. 8, the exemplary display of FIG. 8 shows another view of a care ticket 810, or a portion thereof (e.g., care plan). The care ticket 810 includes a clinical encounter area 814 and a goals area 816. The clinical encounter area 814 includes actions to perform in association with the patient at the current clinical encounter. The clinical encounter area 814 includes an item portion 818, an ordered portion 820, a results portion 822, and a completion portion 824. The item portion 818 includes a list of actions to perform in association with the clinical encounter, the ordered portion 820 includes an indication of whether the action has been performed, initiated, or ordered, and the results portion 822 includes an indication of the results of the corresponding action. The completion portion 824 includes an indication of the extent, percent, or amount of the actions performed (e.g., completed or initiated). The goals area 816 includes an item area 826, a frequency area 828, and a target area 830. The item area 826, the frequency area 828, and the target area 830 may be the same as or similar to the item area 712 of FIG. 7, the frequency area 714 of FIG. 7, and the target area 716 of FIG. 7, respectively.

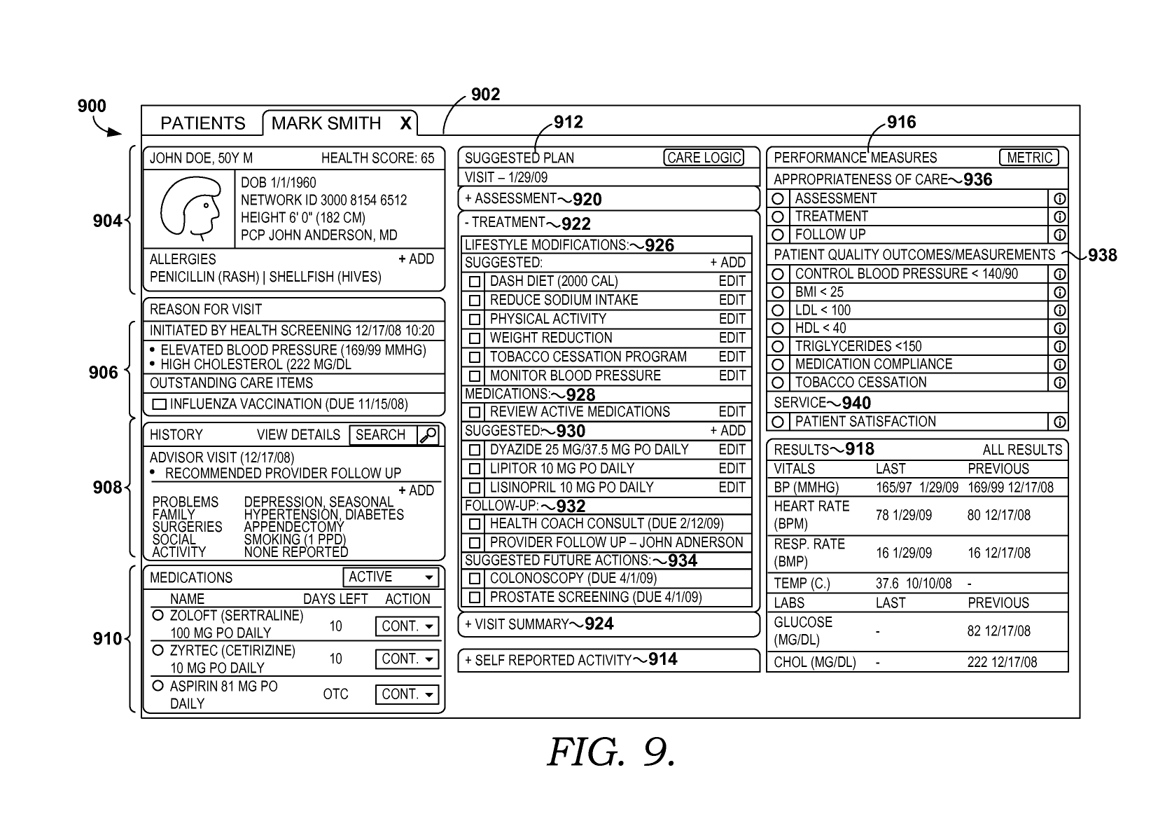

Exemplary display 900 of FIG. 9 illustrates another view of a care ticket 902. As illustrated in FIG. 9, the care ticket 902 may include a patient portion 904, a current clinical encounter portion 906, a patient history portion 908, a medication portion 910, a care plan 912, a self-reported activity portion 914, a performance measure portion 916, and a result portion 918. The patient portion 904 includes basic patient data such as, for example, date of birth, network ID, height, doctor, age, allergies, health score, a photo, etc. The clinical encounter portion 906 includes data relevant to the current clinical encounter such as, for instance, a reason for the present visit and outstanding care items. Such outstanding care items may be outstanding items that are optional to be performed in connection with the patient. In some embodiments, the outstanding care items may only be presented if such items can be performed in association with the present clinical encounter. For example, assume that a evisit resulted in presentation of the care ticket 900. In such a case, the outstanding care item “Influenza Vaccination” might not be presented. Outstanding care items might be care items that are unrelated to the reason for the visit. The patient history portion 908 includes any previous health information, such as, for example, previous clinical encounters, health actions, family history, activity reported, social data, surgeries, problems, etc. As can be appreciated, additional patient history items can be searched, added to, or viewed in more details. The medication portion 910 can provide an indication of any medications associated with the patient (current or previous medications). For example, as illustrated in FIG. 9, a patient's active medications can be listed along with days remaining for taking the medication, an action to take in association with the medication, etc.

The care plan 912 may include an assessment portion 920, a treatment portion 922, and a visit summary portion 924. The assessment portion 920 may include any details or actions associated with assessment of the patient. The treatment portion 922 includes a lifestyle modifications portion 926 that includes proposed or suggested lifestyle modifications for the patient, a medications portion 928 that includes actions associated with medications and suggested medications 930 to prescribe or take, a follow-up portion 932 that includes follow-up actions, and a suggested future actions portion 934 that indicates future actions to take in association with the patient. The visit summary portion 924 may include details or actions that summarize the clinical encounter.

The self-reported activity portion 914 includes, for example, any activity data that is reported or recorded by the patient. By way of example only, activity data might be data related to nutrition or exercise.

The performance measure portion 916 includes an appropriateness of care section 936 that can be used to evaluate or record appropriateness of care with respect to, for example, assessment, treatment, follow up, etc. The performance measure portion 916 also includes a patient quality outcomes/measurements section 938 and a service section 940. The patient quality outcomes/measurements section 938 is used to document patient outcomes and/or measurements, and the service section 940 is used to document patient satisfaction with respect to the service provided to the patient at the clinical encounter.

The result portion 918 provides relevant healthcare results associated with the patient. For example, the result portion 918 might provide results and corresponding dates associated with patient vitals and/or labs. In some cases, the results within the result portion 918 might be previously captured. Alternatively or additionally, the results may be captured at the particular clinical encounter at which the care ticket 902 is presented.

By way of example and with reference to FIGS. 9-11, assume that care ticket 902 is displayed to a care provider at a clinical encounter at which a patient, John Doe, seeks medical care due to elevated blood pressure and high cholesterol, as indicated at the current clinical encounter portion 906 of FIG. 9. Assume that prior to the present clinical encounter, the patient has no history of hypertension. Based on the elevated blood pressure, the care plan 912 includes a suggested prescription of “Lisinopril.” As illustrated in FIG. 10, the care provider indicates performance of each of the suggested lifestyle modifications 1026, medication actions 1028, suggested medications 1030, follow-up actions 1032, and suggested future actions 1034 in care ticket 1002 of FIG. 10. Such indications of performing the recommended actions are aggregated with the other patient data that can result in an update to the PPH for that patient. Further, because the influenza vaccination is overdue for the patient, the care provider also provides the patient with the flu shot and appropriately indicates such an action, as illustrated in current clinical encounter portion 1006 of FIG. 10.

Now assume that, at a later date, the patient visits the doctor for a cough. The care ticket 1102 is displayed to a care provider at a clinical encounter at which the patient seeks medical care for the cough. As illustrated in FIG. 11, the current clinical encounter portion 1106 reflects that the reason for the clinical encounter is due to a cough. The care ticket 1102 is void of the influenza vaccination as an outstanding care item of the vaccine was provided at the previous clinical encounter. Further, a problem now presented in the history data 1108 of the patient appropriately reflects hypertension. Because the patient may be coughing due to the medication of “Lisinopril” previously prescribed to the patient for hypertension, the care plan 1112 is reflected to suggest “Benicar” as a suggested medication 1130 as it is an angiotensin receptor blocker that is less likely to cause a chronic cough.

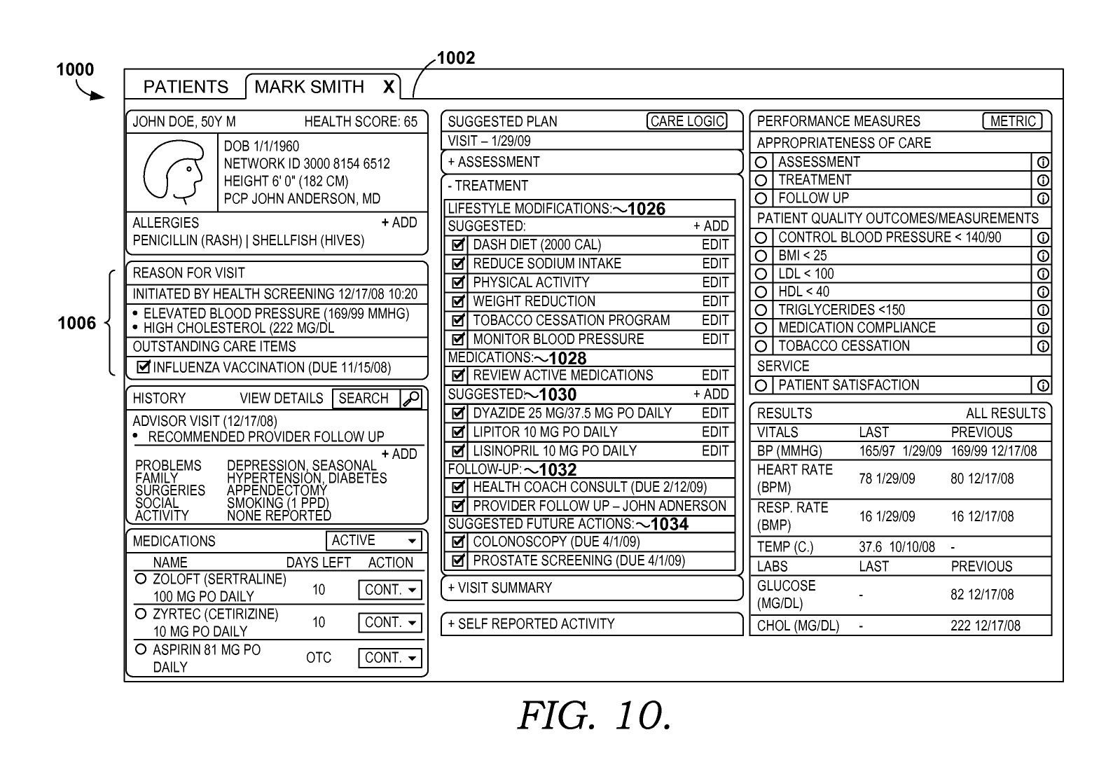

Turning now to FIGS. 12-21, FIGS. 12-21 illustrate various embodiments for developing and/or managing personalized plans of health, or portions associated therewith. With initial reference to FIG. 12, FIG. 12 is a flow diagram showing a method 1200 for facilitating avoidance of potential health complications, in accordance with an embodiment of the present invention. At block 1202, risk data that indicates a potential health risk to a patient is identified. Such risk data can be identified from clinical data associated with a patient. The clinical data might be aggregated from a plurality of sources over a period of time. For example, the clinical data might be aggregated from various clinical encounters at which the patient sought health care services. In one embodiment, the risk data is associated with a particular type of data known to be associated with a risk or medical condition. For example, risk data for a diabetic patient may include a glucose level. In another embodiment, the risk data is identified based on data being outside a preapproved data range. For example, because a glucose level is elevated, such data associated therewith can be identified as risk data.

At block 1204, the risk data and evidence-based data are utilized to determine one or more potential health complications that may arise in association with a patient. Subsequently, at block 1206, a risk profile is developed based on the one or more potential health complications that may arise in association with the patient. Such a risk profile may include a listing of the one or more potential health complications, a probability of the complication(s) occurring, a risk score, a risk summary, a projected financial spending, a potential incentive bonus. As can be appreciated, in some cases, the projected financial spending and the potential incentive bonus are based on the potential health complications as well as the corresponding probability of the occurrence of the complications.

At block 1208, the risk data, the risk profile, and/or the potential health complication(s) are used to identify one or more healthcare actions to perform in association with the patient in an effort to prevent the potential health complication(s). Subsequently, at block 1210, the one or more healthcare actions are included within a personalized plan of health for the patient, a care ticket for the patient, and/or a care plan for the patient. Accordingly, the healthcare action(s) can provide guidance to a care provider or the patient as to healthcare actions to perform to assist in preventing the potential health complication(s).

At block 1212, an indication of performance of at least one of the healthcare action(s) is received. In embodiments, a clinician may indicate performance of a healthcare action(s) via a result 422 of FIG. 4 being provided to the patient data store 404. In this regard, if a clinician performs a health care action, reimbursement can utilize the same infrastructure used to create care tickets and care plans. Such embodiments facilitate eliminating explicit healthcare claims.

At block 1214, a reimbursement amount or an incentive amount is referenced. The reimbursement amount or incentive amount might be calculated or determined prior to or at the time of identifying the healthcare action(s) or might be calculated or determined upon performance of the healthcare action(s). At block 1216, a payment to the care provider or the patient is initiated that corresponds with the reimbursement amount or the incentive amount. In this way, a care provider or a patient might be incentivized to perform various healthcare actions (e.g., exercise, regular checkups of labs, etc.) in an effort to avoid potential health complications that might arise.

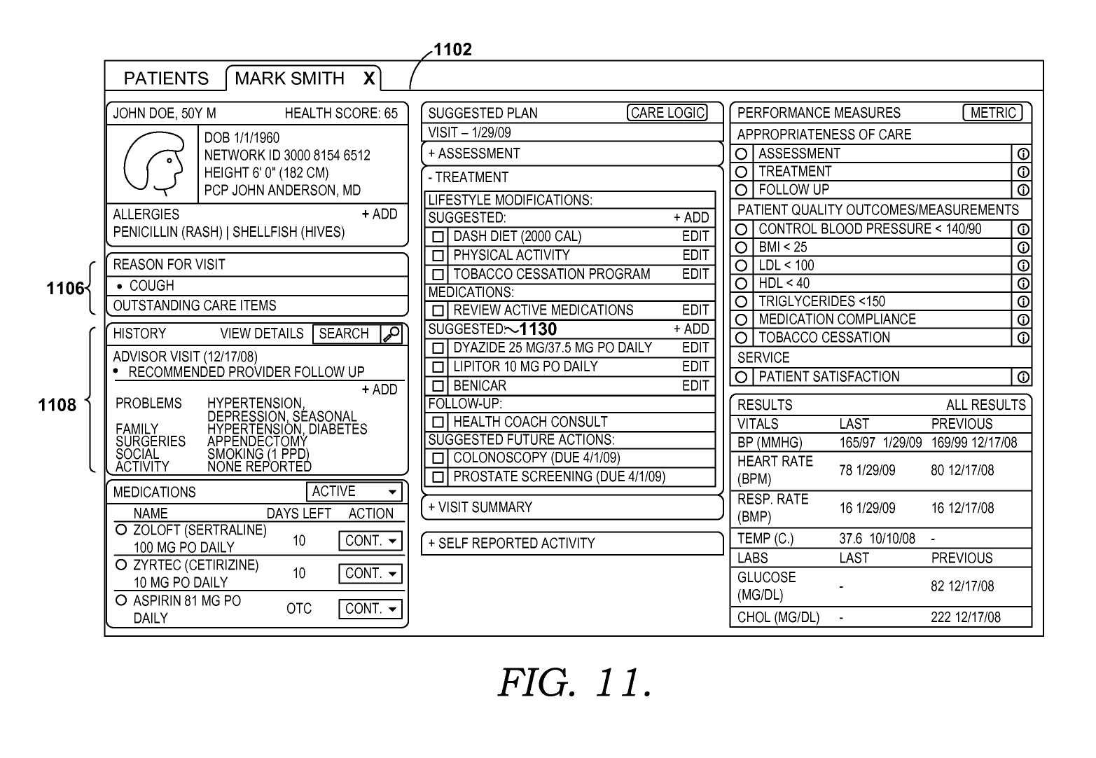

FIG. 13 is a flow diagram showing a first method 1300 for facilitating developing a personalized plan of health, in accordance with an embodiment of the present invention. Initially, at block 1302, clinical data associated with a patient is referenced. The clinical data can be clinical data previously captured from a plurality of sources that provides historical healthcare information for the patient. Such clinical data may include static data that does not change over the lifetime of the patient and dynamic data that does change over the lifetime of the patient. The clinical data and evidence-based data are used to develop a personalized plan of health for the patient. This is indicated at block 1304. The personalized plan of health provides a plan of health care for the patient in accordance with the aggregate healthcare history of the patient.

At block 1306, it is determined if the clinical data associated with the patient is updated (e.g., added, deleted, modified, etc.). In some cases, clinical data is updated based on data provided by the patient. In other cases, clinical data is updated based on data provided by a care provider, for example, in connection with a clinical encounter at which the patient seeks healthcare services. If clinical data associated with the patient is not updated, the method continues to return to block 1306. On the other hand, if clinical data associated with the patient is updated, the personalized plan of health for the patient is updated in accordance with the updated clinical data, as indicated at block 1308. Such an update might occur automatically in response to an update to the clinical data associated with the patient. Alternatively, an update to the personalized plan of health might occur upon receiving an indication for managing a care item (e.g., viewing, generating, or updated a PPH, a care ticket, a care plan, a risk profile, etc.).

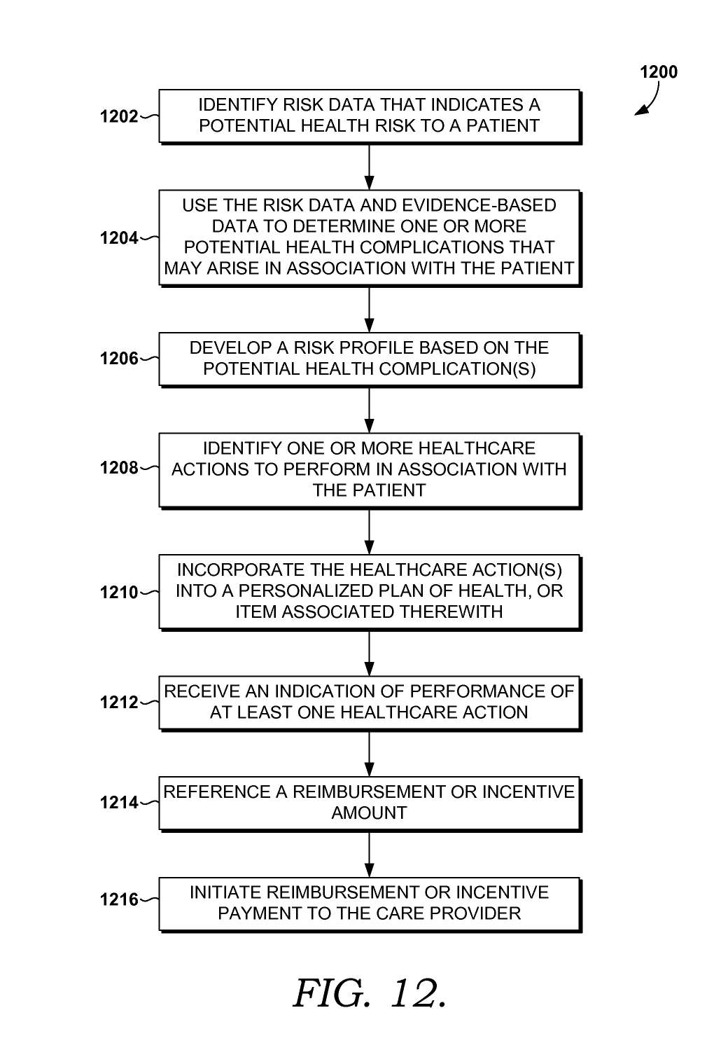

FIG. 14 is a flow diagram showing a second method 1400 for facilitating developing a personalized plan of health, in accordance with an embodiment of the present invention. Initially, at block 1402, a first set of clinical data associated with a patient and evidence-based data are referenced. Subsequently, at block 1404, the first set of clinical data and the evidence-based data are utilized to generate a personalized plan of health for the patient. Such a PPH provides a plan of health care for the patient in accordance with aggregate healthcare history of the patient. At block 1406, the personalized plan of health for the patient is used to generate a first care ticket for a first clinical encounter at which the patient seeks health care services from a first care provider. The first care ticket includes a first set of healthcare actions to perform at the first clinical encounter. At block 1408, an indication of performance of a healthcare action(s) is recognized. The personalized plan of health for the patient is thereafter updated, as indicated at block 1410, based on the indication of the performance of the healthcare action(s). The updated personalized plan of health for the patient is used to generate a second care ticket for a second clinical encounter at which the patient seeks health care services from a second care provider, as indicated at block 1412. The second care ticket includes a second set of healthcare actions to perform at the second clinical encounter.

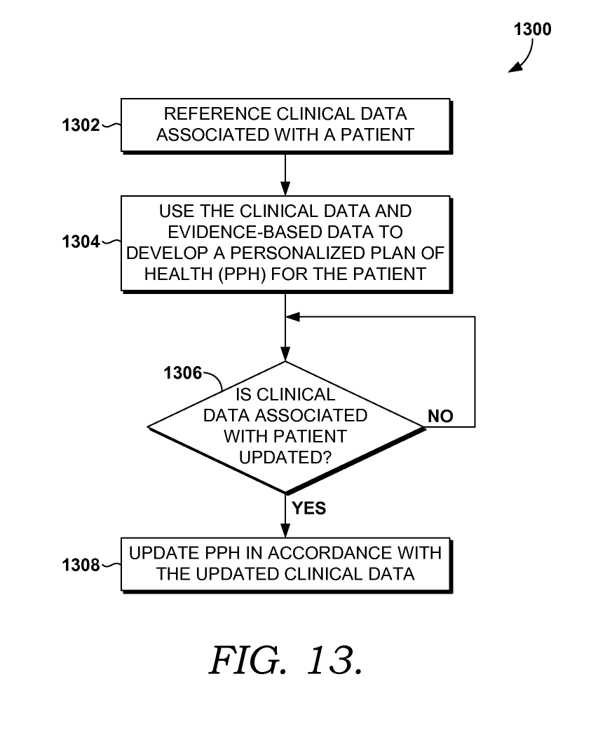

Turning now to FIG. 15, a flow diagram showing a method for developing a care plan, in accordance with an embodiment of the present invention, is illustrated and designated generally as reference numeral 1500. Initially, at block 1510, a patient associated with a clinical encounter is recognized. In embodiments, a patient is recognized using a patient identifier that identifies a patient. A patient identifier can be input by a clinician, by swiping a medical card, or the like. At block 1512, a care provider associated with the clinical encounter is recognized. In embodiments, a care provider is recognized using a care provider identifier that identifies a care provider (e.g., a physician) that can be input by a clinician, by logging in, by swiping a medical card, etc. At block 1514, one or more actions to perform during the clinical encounter are referenced based on the patient and the care provider providing the healthcare services. Such actions to perform may be determined using, for example, clinical context, PPH, patient data, clinical data, risk data, evidence-based data, risk profile, activity data, financial data, etc. In one embodiment, such one or more actions, or a portion thereof, are required to be performed by the care provider to automatically initiate reimbursement. In other embodiments, each of the one or more actions is a medical or healthcare action, that if performed, will be automatically reimbursed. A care plan including the one or more actions to perform during the clinical encounter is provided, as indicated at block 1516. As can be appreciated, the care plan can be included within a care ticket that includes other data associated with the context of the clinical encounter and/or input areas for receiving data, for example, performance completion indications and/or results.

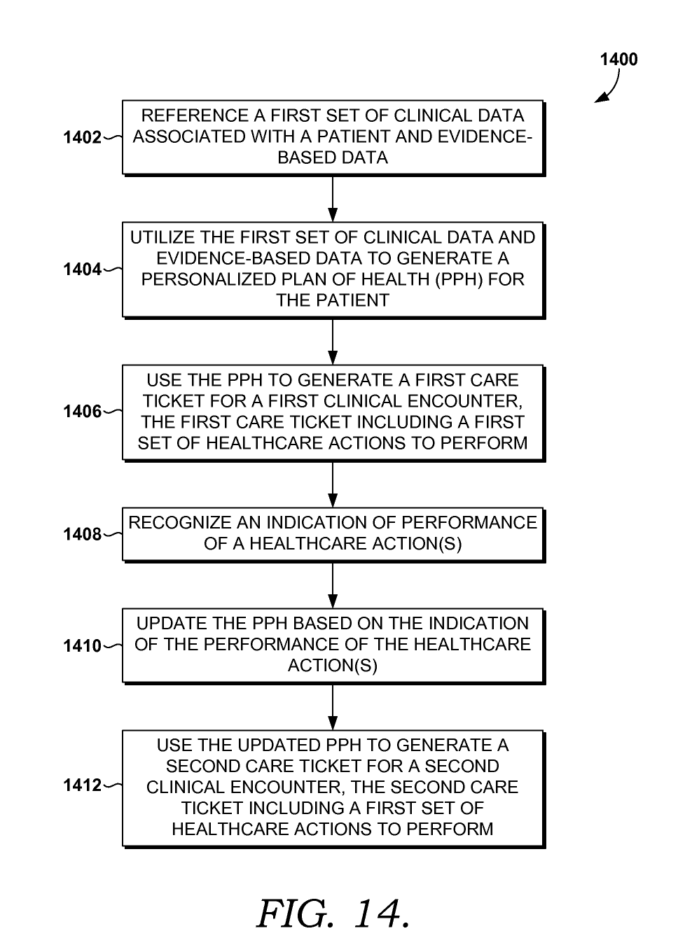

FIG. 16 illustrates a flow diagram showing a method 1600 for developing a care ticket according to an embodiment of the present invention. Initially, as indicated at block 1610, an indication to generate a care ticket for a patient is received. At block 1612, patient data associated with the patient is referenced. Such patient data may be referenced, for example, from various sources or from a source that has aggregated patient data from various sources. Subsequently, at block 1614, the patient data is utilized to identify risk data. Such risk data is patient data that is relevant to health risk to the patient. The risk data are utilized to generate a risk profile for the patient. This is indicated at block 1616. Such a risk profile may include one or more complications (e.g., healthcare or medical) that may arise in association with the patient. At block 1618, a care ticket is generated. The care ticket can be generated using, for example, the patient data, evidence-based knowledge, the risk profile, etc. Such a care ticket may include suggested, recommended, or required medical or healthcare guidelines, procedures, goals, medications to take or prescribe, or actions to perform in association with a patient at a particular clinical encounter to achieve optimum health benefits to the patient.

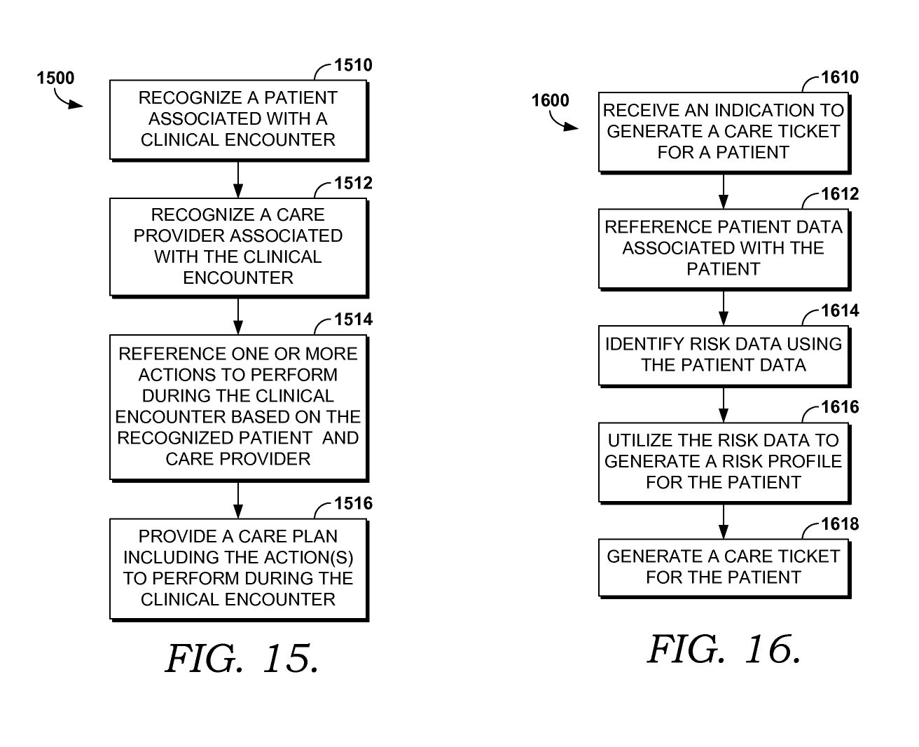

FIG. 17 illustrates a flow diagram showing another method 1700 for developing a care ticket according to an embodiment of the present invention. Initially, at block 1710, context data associated with a clinical encounter at which a patient seeks healthcare services is referenced. The context data can include an indication of a reason the patient is seeking care and/or a care provider to provide care to the patient. At block 1712, clinical data associated with the patient is referenced. In embodiments, such identified clinical data is relevant to the context data. The clinical data, the context data and evidence-based data are used to determine one or more healthcare actions to perform in association with the patient at the clinical encounter, as indicated at block 1714. Subsequently, at block 1716, a care ticket for the patient for the clinical encounter is generated in accordance with the context associated with the clinical encounter. The care ticket includes a set of healthcare actions to perform at the clinical encounter that are deemed acceptable or required for reimbursement. At block 1718, the care ticket is presented to provide guidance to the care provider as to healthcare actions to perform during the clinical encounter.

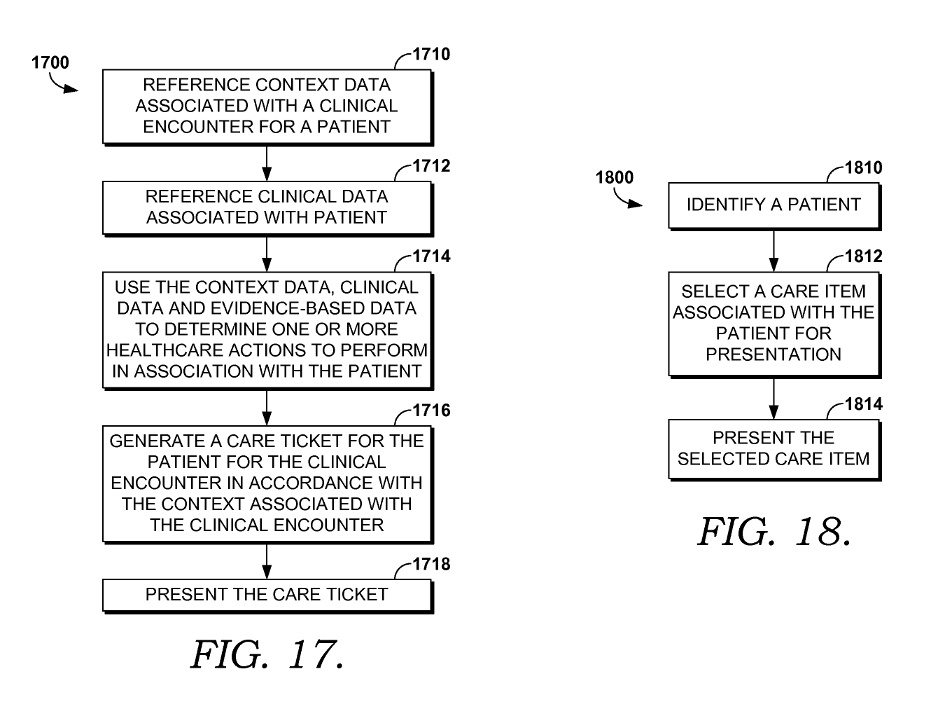

Turning now to FIG. 18, a flow diagram showing a method 1800 for presenting a care item, in accordance with an embodiment of the present invention. Initially, as indicated at block 1810, a patient for which a care item(s) is desired to be viewed is identified, for example, using a patient identifier. At block 1812, a care item associated with the patient is selected for presentation. A care item to present may be selected based on a user indication. For example, upon identifying a patient, a user interface including options to view various care items may be displayed. Thereafter, a user may select, via the user interface, a link to view a PPH, a care plan, a care ticket, risk data, a risk profile, etc. Alternatively, a default care item may be selected for presentation, for example, upon viewing a patient record. In embodiments, various data may be used to select a care item for presentation. For example, provider data (e.g., care provider identification) or clinical context data (e.g., date of clinical encounter, reason for visit) may be used to select a care item for presentation. At block 1814, the selected care item is presented, for example, to a user via a display screen. In this regard, if a user desires to view a care plan, the care plan is displayed.

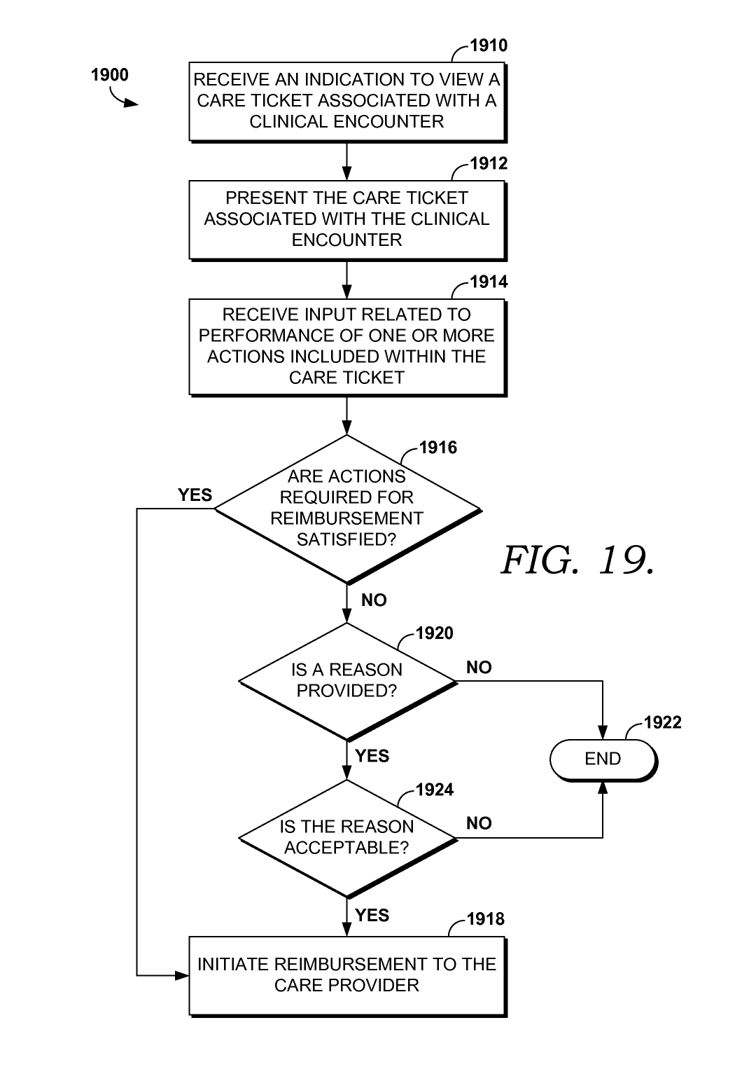

Turning now to FIG. 19, a flow diagram showing a first method for reimbursing a care provider, in accordance with an embodiment of the present invention, is illustrated and designated generally as reference numeral 1900. At block 1910, an indication to view a care ticket associated with a clinical encounter is received. At block 1912, a care ticket associated with the clinical encounter is presented to a user. The care ticket includes one or more actions to perform during the clinical encounter. The particular care ticket associated with the clinical encounter may be based on, for example, the patient, the care provider, context data (e.g., the date of the clinical encounter), etc. As can be appreciated, the care ticket can be generated in real-time (e.g., upon receiving an indication to view the care ticket) or generated in advance of the clinical encounter. The care ticket, or a portion thereof, may be based on actions that have been preapproved (e.g., selected or verified) as medically appropriate such that reimbursement of the actions, if performed, will be reimbursed. Such a care ticket and actions therein can be developed, for example, using patient data, such as patient data associated with a PPH.

At block 1914, input related to performance of one or more actions included within the care ticket is received. Subsequently, at block 1916, it is determined whether actions within the care ticket required for reimbursement have been satisfied. The required actions may include actions deemed medically appropriate actions and/or actions preapproved or preauthorized as suitable for reimbursement, if performed. If the required actions of the clinical ticket have been satisfied, at block 1918, reimbursement to the care provider is initiated. If, however, the required actions of the clinical ticket have not been satisfied, the care provider is given an opportunity at block 1920 to explain or justify the care provided or omitted relative to the care ticket. If a reason is not provided, the method ends at block 1922. If, however, a reason is provided, it is determined whether the reason is acceptable at block 1924. If the reason provided by the clinician is acceptable, reimbursement to the care provider is initiated at block 1918. If, on the other hand, the reason provided by the clinician is not acceptable, the method ends at block 1922. Data input by a care provider can be aggregated along with the other clinical data for the patient such that care items can be updated in accordance with the newly obtained data.

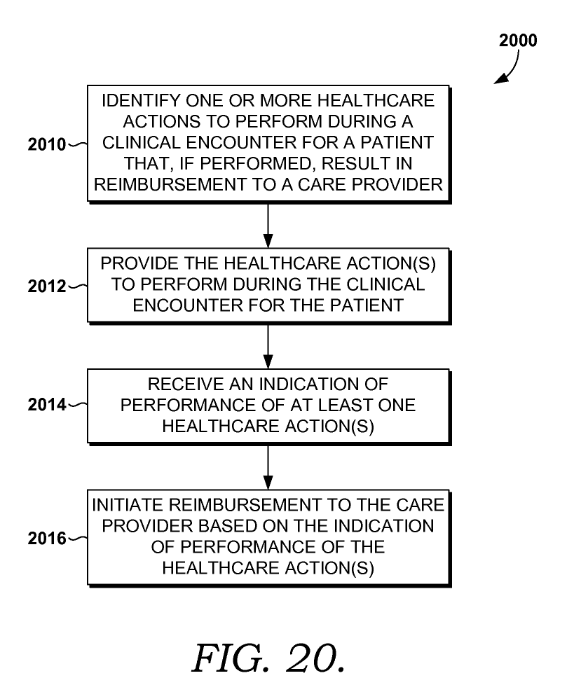

FIG. 20 illustrates a second method for reimbursing a care provider, in accordance with an embodiment of the present invention, and is generally referenced as numeral 2000. At block 2010, one or more healthcare actions to perform during a clinical encounter for a patient are identified. The identified healthcare action(s), if performed, result in a reimbursement to a care provider. Such healthcare actions might be determined based on, for example, clinical data, evidence-based data, context data associated with the clinical encounter, financial data, activity data, risk data, etc. At block 2012, the healthcare action(s) to perform during the clinical encounter for the patient are provided. Such healthcare actions might be provided in a PPH, a care ticket, a care plan, or in an alternative manner. At block 2014, an indication that at least one of the healthcare actions has been performed (e.g., initiated or completed) during the clinical encounter is received. Based on the performance of the at least one healthcare action(s), as indicated at block 2016, reimbursement to the care provider is automatically initiated. Because the identified healthcare action(s) resulted in reimbursement if performed, upon performing such actions, the care provider can be automatically reimbursed without having to determine a reimbursement amount and/or verify reimbursement is acceptable after performing actions.

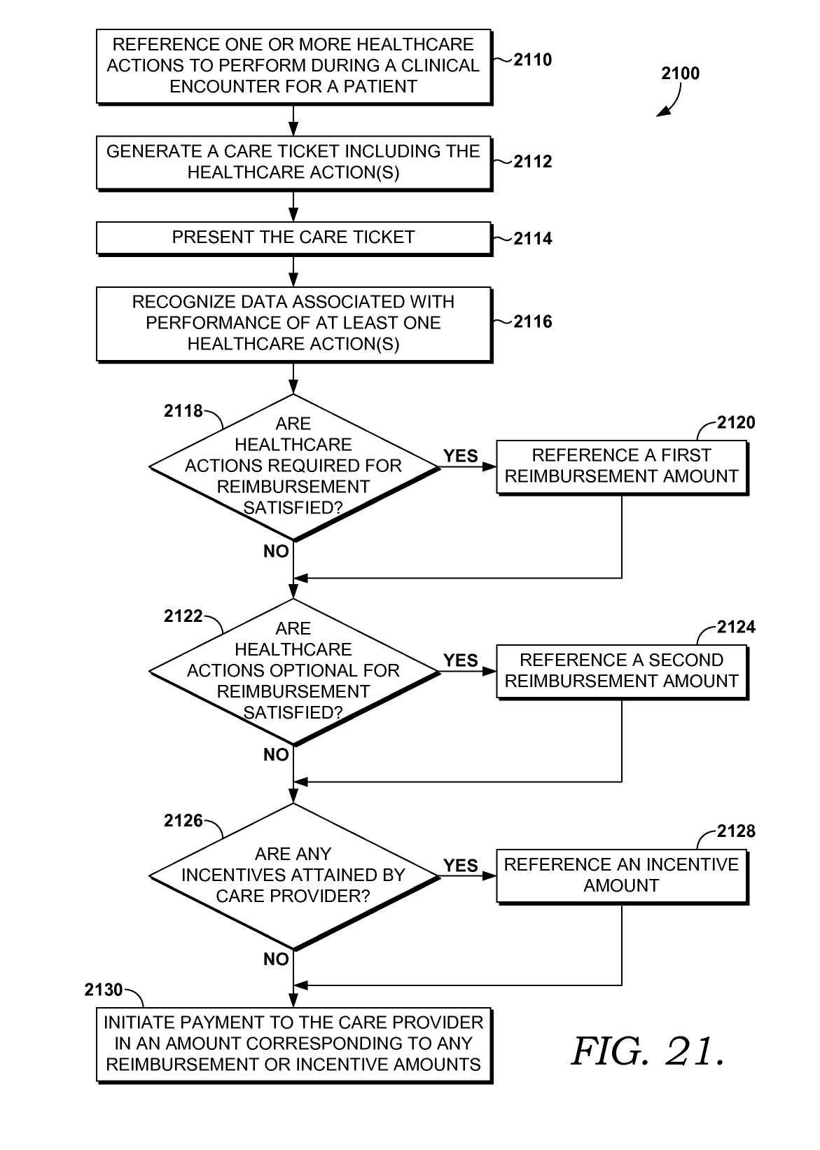

FIG. 21 illustrates a third method for reimbursing a care provider, in accordance with an embodiment of the present invention, and is generally referenced as numeral 2100. At block 2110, one or more healthcare actions to perform during a clinical encounter for a patient are referenced. In embodiments, such healthcare actions are preapproved for reimbursement (e.g., required for reimbursement, optional for reimbursement, suggested for reimbursement, etc.). The healthcare actions to perform can be determined, for instance, based on context data of the clinical counter, clinical data, financial data, risk data, activity data, etc. At block 2112, a care ticket including the healthcare action(s) is generated. The care ticket is presented, as indicated at block 2114. At block 2116, data associated with performance of at least one of the healthcare actions is recognized. Such received data may include, for example, an indication of performance, results or outcomes associated with performance, patient satisfaction, etc.

At block 2118, it is determined if healthcare actions required for reimbursement were performed. If so, a first reimbursement amount is referenced, as indicated at block 2120, and the method continues to block 2122. Such a first reimbursement amount might be determined at any time, for example, prior to presenting the care ticket having a healthcare action required for reimbursement or upon receiving data associated with performance of the healthcare actions. If not, the method continues to block 2122.

At block 2122, it is determined if any optional healthcare actions were performed. If so, a second reimbursement amount is referenced, as indicated at bock 2124, and the method continues to block 2126. The second reimbursement amount might be determined at any time, for example, prior to presenting the care ticket having an optional healthcare action or upon receiving data associated with performance of the optional healthcare action. If not, the method continues to block 2126.

At block 2126, it is determined if any incentives have been attained by the care provider. An incentive might be, for example, attaining an extent of quality for the patient at the clinical encounter, attaining an extent of quality for a set of patients, attaining a health result for the patient, attaining health results for a set of patients, or the like. As can be appreciated, such incentives may be provided in the care ticket such that the care provider can view the incentives or data associated therewith. If so, an incentive amount is referenced, as indicated at bock 2128, and the method continues to block 2130. The incentive amount might be determined at any time, for example, prior to presenting the care ticket or upon receiving data associated with care ticket. If not, the method continued to block 2130. At block 2130, a payment(s) to the care provider is initiated in an amount that corresponds with any reimbursement or incentive amounts.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and within the scope of the claims.

What is claimed is:

1. One or more computer storage media having computer-executable instructions embodied thereon for performing method for reimbursing care providers, the method comprising:
identifying one or more medically appropriate actions to perform during a clinical encounter for a patient that, if performed, result in a reimbursement to a care provider;
providing the one or more medically appropriate actions to perform during the clinical encounter for the patient;
receiving an indication that the one or more medically appropriate actions have been performed during the clinical encounter; and
based on the performance of the one or more medically appropriate actions, automatically initiating the reimbursement to the care provider.

2. The media of claim 1, wherein the one or more medically appropriate actions are performed by initiating or completing each of the one or more medically appropriate actions.

3. The media of claim 1, wherein the one or more medically appropriate actions are identified based on potential health complications that may arise in association with the patient.

4. The media of claim 3, wherein the one or more medically appropriate actions are identified using evidence-based data in association with the patient health data comprising aggregated clinical data associated with the patient.

5. The media of claim 1, wherein the one or more medically appropriate actions are approved for the reimbursement prior to providing the one or more medically appropriate actions to the care provider.

6. The media of claim 1 further comprising receiving one or more results associated with the one or more medically appropriate actions.

7. The media of claim 1, wherein reimbursement is initiated in real-time without requiring an analysis of medical appropriateness after performance of the one or more medically appropriate actions.

8. The media of claim 6 further comprising aggregating the one or more results associated with the one or more medically appropriate actions with clinical data corresponding with the patient.

9. One or more computer storage media having computer-executable instructions embodied thereon for performing a method for reimbursing care providers, the method comprising:
providing a care ticket associated with a patient for a particular clinical encounter, the care ticket including one or more healthcare actions to perform during the particular clinical encounter that have been preapproved for reimbursement to a care provider; and
in response to an indication that the one or more healthcare actions were performed during the particular clinical encounter, initiating reimbursement to the care provider for performance of the one or more healthcare actions.

10. The media of claim 9, wherein the one or more healthcare actions to perform during the particular clinical encounter have been preapproved based on a determination of medical appropriateness.

11. The media of claim 10, wherein medical appropriateness is determined using clinical data associated with the patient and evidence-based data.

12. The media of claim 9, wherein the one or more healthcare actions to perform during the particular clinical encounter have been preapproved by the payer at least based on financial data.

13. The media of claim 12, wherein the financial data includes one or more of a procedure code, a physician identification, an insurance or other coverage data, an eligibility requirement, and a benefit reimbursement level.

14. The media of claim 9, wherein the care ticket is provided in response to a selection to view the care ticket associated with the patient.

15. The media of claim 9, wherein a user provides the indication that the one or more healthcare actions were performed upon completing or initiating performance of the one or more healthcare actions during the clinical encounter.

16. A method for reimbursing care providers, the method comprising:
identifying one or more healthcare actions to perform during a clinical encounter for a patient that, if performed, result in reimbursement to the care provider, wherein the identified healthcare actions are based on clinical data associated with the patient and evidence-based data;
prior to providing the one or more healthcare actions in association with the clinical encounter, verifying that the one or more healthcare actions are deemed acceptable for reimbursement for performance of the one or more healthcare actions;
providing the one or more healthcare actions to perform during the clinical encounter for the patient;
receiving an indication that at least one of the one or more healthcare actions have been performed during the clinical encounter; and
based on the indication of performance of the at least one of the one or more healthcare actions, initiating reimbursement to the care provider in real-time.

17. The method of claim 16, wherein reimbursement is initiated upon performance of each of the one or more healthcare actions.

18. The method of claim 16, wherein reimbursement is initiated in association with each of the at least one of the one or more healthcare actions performed during the clinical encounter.

19. The method of claim 16, wherein the performance of the at least one of the one or more healthcare actions is achieved by completing or initiating the corresponding healthcare actions.

20. The method of claim 16 further comprising providing a notification to a user to indicate that reimbursement has been initiated.
